(19) United States
(12) Patent Application Publication
(10) Pub. No.: US 2026/0105545 A1
(43) Pub. Date: Apr. 16, 2026

(54) Multimodal Content Feature Extraction for Action Data Structure Generation and Execution

(71) Applicant: Uber Technologies, Inc., San Francisco, CA (US)

(72) Inventors: Michael Peter Bieniek, Toronto (CA); Erin Gallagher, Toronto (CA); Utkarsh Garg, Toronto (CA); Isabel Klein, Seattle, WA (US); Anirudha Nandi, Toronto (CA); Garvit Jayeshkumar Patel, New York, NY (US); Andrei Soltan, Toronto (CA)

(21) Appl. No.: 18/916,158

(22) Filed: Oct. 15, 2024

(51) Int. Cl. G06Q 50/12; G06Q 10/0835; G06Q 10/0875

(52) U.S. Cl. CPC G06Q 50/12; G06Q 10/0835; G06Q 10/0875

(57) ABSTRACT

Systems and methods for multimodal content feature extraction for action data structure generation and execution. The system can access multimodal content item data. The system can process the multimodal content item data to generate a number of data objects including comestible items and context data. The system can process the data objects to generate a predicted dish and dish data. The system can generate a list data structure including a number of ingredients and quantities of the ingredients. The system can determine a deliverability status of the list data structure and generate an action data structure including instructions that are executable to cause initiation of a comestible item delivery service. The data associated with the multimodal content item and action data structure can be transmitted to a client device to be provided for display.

### FIELD

The present disclosure generally relates to feature extraction from multimodal content for use in action data structure generation and execution. More particularly, the present disclosure is directed to features for determining comestible items within multimodal content items and facilitating delivery of the comestible items.

### BACKGROUND

Food delivery services allow a user to request a service that may be performed by a vehicle and/or courier. For instance, a user may request, through a food delivery service application, a food delivery service having a pick-up location, a drop-off location, and an item for delivery. A courier can be assigned to perform the food delivery service for the user. This can include transporting the delivery of the item to the drop-off location. In some cases, food delivery service applications can provide for multimedia content associated with dishes.

### SUMMARY

Aspects and advantages of embodiments of the present disclosure will be set forth in part in the following description, or may be learned from the description, or may be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include accessing multimodal content item data. The operations include processing the multimodal content item data to generate a plurality of data objects comprising at least (i) one or more comestible items and (ii) context data. The operations include processing the plurality of data objects to generate a predicted dish and dish data. The operations include generating, based on the predicted dish and dish data, a list data structure comprising a plurality of ingredients and quantities of the respective ingredients. The operations include processing the list data structure against a comestible item delivery service data structure to determine a deliverability status associated with the list data structure. The operations include determining that the deliverability status for the list data structure indicates a deliverable status. The operations include generating, automatically and responsive to determining that the deliverability status for the list data structure indicates the deliverable status, an action data structure, the action data structure comprising instructions, that are executable by one or more processors of a client device to cause initiation of a service request comprising one or more available items via an application programming interface associated with the comestible item delivery service. The operations include transmitting data comprising the multimodal content item and the action data structure to the client device.

Another Example aspect of the present disclosure is directed to a computer-implemented method. The method includes accessing multimodal content item data. The method includes processing the multimodal content item data to generate a plurality of data objects comprising at least (i) one or more comestible items and (ii) context data. The method includes processing the plurality of data objects to generate a predicted dish and dish data. The method includes generating, based on the predicted dish and dish data, a list data structure comprising a plurality of ingredients and quantities of the respective ingredients. The method includes processing the list data structure against a comestible item delivery service data structure to determine a deliverability status associated with the list data structure. The method includes determining that the deliverability status for the list data structure indicates a deliverable status. The method includes generating, automatically and responsive to determining that the deliverability status for the list data structure indicates the deliverable status, an action data structure, the action data structure comprising instructions, that are executable by one or more processors of a client device to cause initiation of a service request comprising one or more available items via an application programming interface associated with the comestible item delivery service. The method includes transmitting data comprising the multimodal content item and the action data structure to the client device.

Yet another example aspect of the present disclosure is directed to one or more non-transitory computer readable media storing instructions that are executable by one or more processors to perform operations. The operations include accessing multimodal content item data. The operations include processing the multimodal content item data to generate a plurality of data objects comprising at least (i) one or more comestible items and (ii) context data. The operations include processing the plurality of data objects to generate a predicted dish and dish data. The operations include generating, based on the predicted dish and dish data, a list data structure comprising a plurality of ingredients and quantities of the respective ingredients. The operations include processing the list data structure against a comestible item delivery service data structure to determine a deliverability status associated with the list data structure. The operations include determining that the deliverability status for the list data structure indicates a deliverable status. The operations include generating, automatically and responsive to determining that the deliverability status for the list data structure indicates the deliverable status, an action data structure, the action data structure comprising instructions, that are executable by one or more processors of a client device to cause initiation of a service request comprising one or more available items via an application programming interface associated with the comestible item delivery service. The operations include transmitting data comprising the multimodal content item and the action data structure to the client device.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system for multimodal content feature extraction for action data structure generation and execution according to aspects of the present disclosure.

FIG. 2 depicts a block diagram of an example computing system for multimodal content feature extraction for action data structure generation and execution according to aspects of the present disclosure.

FIG. 3 depicts a block diagram of models associated with an example computing system for multimodal content feature extraction for action data structure generation and execution according to aspects of the present disclosure.

FIG. 4 depicts a flowchart of an example method according to example embodiments of the present disclosure.

FIG. 5 depicts a flowchart of an example method according to example embodiments of the present disclosure.

FIG. 6 depicts a flowchart of an example method according to example embodiments of the present disclosure.

FIG. 7 depicts a flowchart of an example method according to example embodiments of the present disclosure.

FIG. 8 depicts a flowchart of an example method according to example embodiments of the present disclosure.

FIG. 9 depicts an example graphical user interface according to example embodiments of the present disclosure.

FIG. 10 depicts an example graphical user interface according to example embodiments of the present disclosure.

FIG. 11 depicts an example graphical user interface according to example embodiments of the present disclosure.

FIG. 12 depicts an example graphical user interface according to example embodiments of the present disclosure.

FIG. 13 depicts an example graphical user interface according to example embodiments of the present disclosure.

FIG. 14 depicts an example graphical user interface according to example embodiments of the present disclosure.

FIG. 15 depicts a block diagram of an example computing system according to example embodiments of the present disclosure.

FIG. 16 depicts a block diagram of an example computing system according to example embodiments of the present disclosure.

FIG. 17 depicts a block diagram of training one or more machine-learned models according to example embodiments of the present disclosure.

FIG. 18 depicts an example network including a network computing system and machine learning computing system according to example embodiments of the present disclosure.

### DETAILED DESCRIPTION

Generally, the present disclosure is directed to improved systems and methods for processing multimodal content such as video, image, or sound to extract features which can be used to generate action data structures. Multimodal content can include a combination of media modalities. For instance, the combination of media modalities can include images, audio, text, video, linguistic, spatial, or motion. In some instances, multimodal content can include multimedia content. The action data structures can be executed over application interfaces. For instance, the computing systems and methods can generate data objects associated with comestible menu items that are found in the multimodal content. The data objects can be generated based on features extracted from processing the multimodal content. The data objects can be utilized to generate action data structures which can be used to efficiently store and communicate data which can be executed via application programming interfaces to initiate service requests with comestible item delivery services.

The action data structure can be transmitted via an application programming interface of a comestible item delivery service. Upon receipt of the action data structure, a service request can be initiated including a number of ingredients associated with the data objects (e.g., food item) detected in the multimodal content item. For instance, a video can be displayed within a delivery service application associated with the comestible item delivery service. The video can be displayed in various formats such as short form in a vertically scrolling interface, a carousel, or can be presented via a bounding box amidst a number bounding boxes presenting different content items within a display simultaneously.

In some instances, the content can be ranked and displayed based on user-specific data, session-specific data, or content item specific data such that the content can allow for a user to discover new types of cuisine or be provided with multimodal content items that are associated with deliverable dishes (e.g., dishes which have ingredients that can be currently purchased based on merchant inventory and store hour availability). As such, novel recommendation engines must be generated to provide for selection and ranking of content items that provide for new discoverable content. Additionally, the present disclosure can provide for processing the multimodal content items such that one or more comestible menu item can be extracted from the content.

In some implementations, the computing system can categorize the video as a recipe video, unboxing video, delivery video, how the dish is made video, or some other category of video. The category of the video can affect how the video or other multimodal content is processed by the computing system to determine a deliverability status of the item. For instance, a recipe video can be associated with individual ingredients associated with a grocery store. Additionally, or alternatively, a recipe video can be processed to determine the end result such that items available at a restaurant that are the same or similar to the item made can be purchased.

In some instances, a single action data structure can be generated for a multimodal content item. Additionally, or alternatively, a number of action data structures can be generated based on a multimodal content item. For instance, a first action data structure can be generated for purchasing the individual ingredients and a second action data structure can be generated for purchasing a prepared dish. These action data structures can be structurally distinct such that they can be processed by different delivery systems without introducing latency from translating the data from one format to another. In some instances, the action data structures can be associated with different back-end software services. For instance, a first software service can be associated with a food delivery service and a second software service can be associated with a grocery delivery service. There are many potential options for generation and execution of the action data structures among one or more software services. As such, once processing of an action data structure is initiated, it can be processed without additional latency or real-time network or bandwidth usage from translating the action data structure from one form to another.

In some instances, the action data structures can be generated based at least in part on contextual data associated with the multimodal content. For instance, the contextual data associated with the video can help determine how the video should be processed and determine which merchants may have relevant dishes available for purchase or relevant ingredients available for a recipe. As such, the categorized video can be processed to generate data objects including one or more items which can be “added to a cart” by executing a service request action data structure or generating instructions for a recipe associated with a dish being made within the multimodal content item.

The present disclosure can provide for a number of system components that can include multimodal content processing models, cuisine type determination models, video recommendations models, and similar dish models. For instance, the computing system can determine a type of cuisine associated with the multimodal content and provide a recommendation for the content. Each model can be continually trained or updated based on feedback data which can be gathered or generated by the computing system. In some instances, the models can be machine-learned models which can be trained via supervised or unsupervised learning. In some instances, the multimodal content processing models can include large language models capable of processing videos, images, text, audio, or other data to extract features associated with the content and generate data structures which can be parsed. As such, the present disclosure provides for bespoke models which can provide for efficient processing of multimodal content to generate actionable data structures while reducing latency and network resource utilization. The machine-learned models can be specifically trained to extract comestible item related data from content items. Additionally, the present disclosure can include checks within the system to determine that items within a video are deliverable before providing them. For instance, the machine-learned model can provide a citation or other indication of where the item is found in an inventory or on a menu. Further, by making an initial determination about whether an item is currently deliverable, the system can prevent unnecessary processing and can conserve computing resources.

The technology of the present disclosure can provide a number of technical effects and benefits. For instance, aspects of the described technology can allow for more efficient and intelligent processing of action data structures to perform operations based on features that are extracted from multimodal content. In some instances, processing of the action data structure can automatically trigger a state change at a merchant device or other physical alert associated with the action data structure. For instance, a state change can trigger the sounding of an alert, a visual indicator, or in some instances can trigger a system to begin preparation or organizing of one or more items associated with the action data structure. For instance, processing the action data structure by a merchant system can trigger a physical item associated with the preparation of the food item to turn on or begin preparation. By way of example, actions can include, but are not limited to, turning on a stove, setting an oven to a particular temperature, removing an item from packaging. In some instances, a physical action that is triggered can include utilizing an autonomous machine to locate items within a merchant to be packaged for pickup by a courier.

The technology described herein includes the collection of data and provision of certain content to users associated with a delivery service. Users can be given the opportunity to customize data collection and provision features. Data collection and provision can be configured with options for permissions to be obtained from users such that data is collected or provided for authorized use in accordance with the disclosed techniques. For example, a user can control whether certain usage data is collected and/or whether certain content is provided to the user (e.g., through opt-out features, settings). Any personal data can be removed, and data can be stored in a secured, anonymized manner. In this manner, the users can be provided control over what data is collected, used, and provided to a user for the implementations described herein.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. With reference to the figures, example embodiments of the present disclosure will be discussed in further detail.

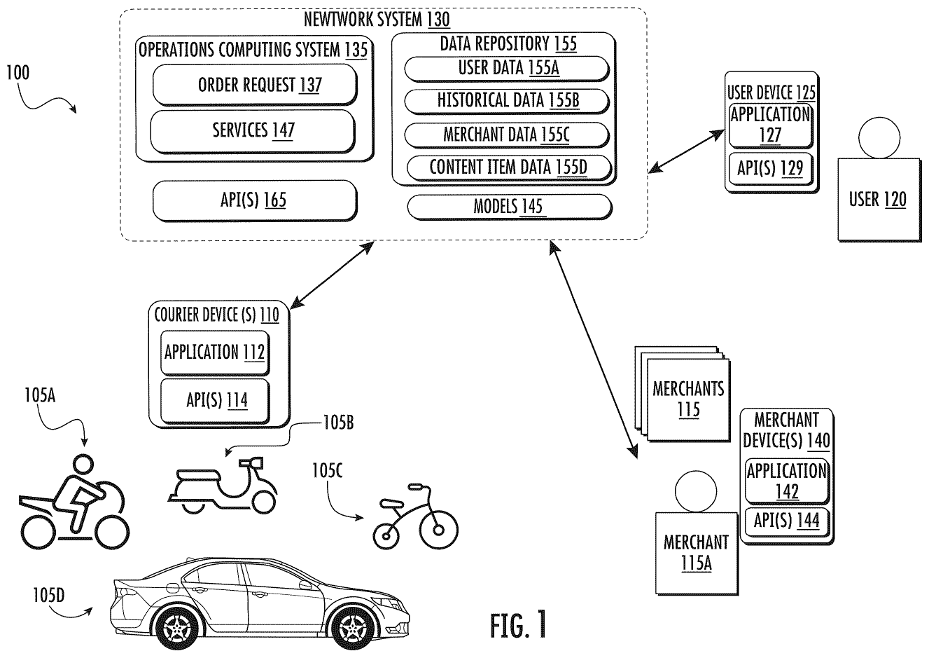

FIG. 1 depicts a block diagram of an example computing system 100 for multimodal content feature extraction for action data structure generation and execution via a delivery service application. As illustrated, FIG. 1 shows a computing system 100 that can include one or more vehicles 105A-D (e.g., a car, scooter, motorcycle, bicycle) and one or more courier devices 110 that can be associated with one or more couriers. In some examples, the one or more couriers are humans. In some examples, the courier can be non-human (e.g., vehicle, autonomous vehicle, autonomous robot). The one or more couriers and the one or more courier devices 110 (e.g., an onboard tablet, a mobile device of a courier) can be associated with the one or more vehicles 105A-D. The courier device(s) 110 can include a software application 112 associated with the food delivery service entity, which can run on the courier device(s) 110. The courier device(s) 110 can include one or more application programming interfaces (API(s) 114) for facilitating communication between the courier device(s) 110 and the network system 130.

The computing system 100 can include one or more merchants 115. The merchants 115 can receive data indicative of a food delivery service request from a user 120. A food delivery service request can include a request for premade items from a restaurant or delivery of ingredients from a grocery store. For example, the user 120 can submit a request through a user device 125 associated with the user (e.g., via a software application 127 or API(s) 129). A network system 130 can include an operations computing system 135 associated with a service entity that can facilitate a request for services from user 120.

An operations computing system 135 associated with the food delivery service entity can facilitate a request for services from user 120. For example, the user 120 can submit a food delivery request through a user device 125 associated with the user 120 (e.g., via a software application 127). Operations computing system 135 can receive a food delivery service request for an order request 137 from a user device 125. The operations computing system 135 can send data indicative of order request 137 to a merchant device 140 associated with a merchant 115A (e.g., via a software application 142 or API(s) 144).

In some implementations, merchant devices 140 can aggregate service requests from a plurality of systems. For instance, the plurality of systems can be associated with a plurality of different entities. By way of example, network system 130 can be one system of the plurality of systems. The API(s) 144 can be structured such that the merchant devices can receive order request data 137 from the network system 130 and aggregate the order request data 137 with additional order request data from other sources. In some instances, the other sources can include additional service entities. As such, the merchant devices 140 can facilitate completion of service requests received from systems and applications in addition to a software application directly associated with network system 130. This can be accomplished, for example, via an aggregator software application that is programmed to access the service requests via a plurality of APIs and display them on the merchant devise 140 through a user interface.

The operations computing system 135 can receive data indicative of a merchant 115A accepting a food preparation request (e.g., food being prepared, estimated preparation time, estimated shopping time for grocery items). The operations computing system 135 can send a request to a courier device 110 associated with the courier to complete the order request 137 (e.g., via application 112 or API(s) 114).

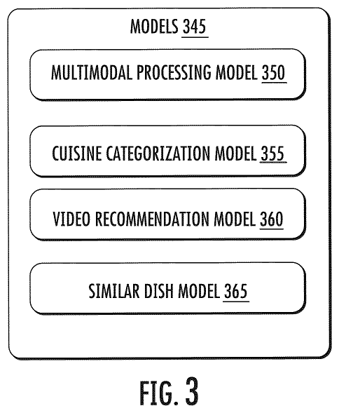

The network system 130 can include models 145. Models 145 can include a multimodal processing model, a cuisine categorization model, a video recommendation model, or a similar dish model. The models 145 will be described in further detail with regard to FIG. 3. In some instances, models 145 can include a single model. In some instances, models 145 can include multiple models.

The network system 130 can include a data repository 155. The data repository 155 can include user data 155A (e.g., data associated with user 120), historical data 155B (e.g., data associated with user 120, data associated with merchant(s) 115, data associated with couriers), merchant data 155C (e.g., real-time data associated with merchants 115), content item data 155D (e.g., data associated with one or more multimodal content items), or any other relevant data (e.g., system-level data associated with a plurality of users, expected demand).

The technology described herein includes the collection of data and provision of certain content to users associated with a delivery service. Users can be given the opportunity to customize data collection and provision features. Data collection and provision can be configured with options for permissions to be obtained from users such that data is collected or provided for authorized use in accordance with the disclosed techniques. For example, a user can control whether certain usage data is collected and/or whether certain content is provided to the user (e.g., through opt-out features, settings). Any personal data can be removed, and data can be stored in a secured, anonymized manner. In this manner, the users can be provided control over what data is collected, used, and provided to a user for the implementations described herein

The models 145 can use data from the data repository 155 to extract feature data from content item data 155D. The extracted feature data can be utilized to surface one or more recommended items, ingredients, or merchants which can be surfaced for display on a user device 125 (e.g., via application 127). Additionally, or alternatively, the extracted feature data can be utilized to generate action data structures that are executable by the network system 130 to initiate and order request.

The operations computing system 135 can generate data indicative of the order request 137 or an action data structure associated with an order request. Data indicative of the order request 137 can include, for example, estimated time of departure, estimated time of arrival, estimated preparation time, real-time updates on order preparation, real-time updates on order location. An action data structure associated with an order request can, for example, be executed by the network system 130 to initiate and facilitate completion of order request 137. The operations computing system 135 can provide data for display on a user device 125 (e.g., via application 127) indicative of updates on the order request 137. For example, an update can include an update about what stage of delivery the order is in. Stage of delivery can include, for example, preparation, pick-up by courier, courier in route, approaching delivery, or delivered.

An operations computing system 135 associated with the service entity can receive an order request 137 from the user device 125. The operations computing system 135 can send a request to a courier device 110 associated with a courier (e.g., via a software application 112 or API(s) 114) for the courier to perform the requested order request service. The courier can be associated with the vehicle (e.g., vehicle 105A-D).

The operations computing system can communicate data indicative of the food delivery service assignment to a courier. A courier can include, for example, a human courier, an autonomous vehicle courier, an autonomous robot courier. For instance, the operations computing system 135 can send a request to the courier device 110 of the courier. The request (e.g., for the courier to accept the food delivery service assignment) can be communicated to the courier via the software application 112 running on the courier device 110 associated with the courier. Additionally, or alternatively, the operations computing system 135 can send a request to a vehicle device(s) 110 (e.g., a tablet stored onboard the vehicle) of at least one of vehicles 105A-D. The request (e.g., for the courier to accept the food delivery service assignment) can be communicated to the courier via the software application 112 running on a courier device 110. The courier can provide user input to the courier device 110 (e.g., via the software application 112) to accept or decline the vehicle service assignment. In some examples, user input can be provided directly into a service application. Additionally, or alternatively, user input can be provided via an application programing interface (API) (e.g., API(s) 114) and/or a third-party application. Data indicative of the acceptance or rejection of the request can be provided to the operations computing system 135.

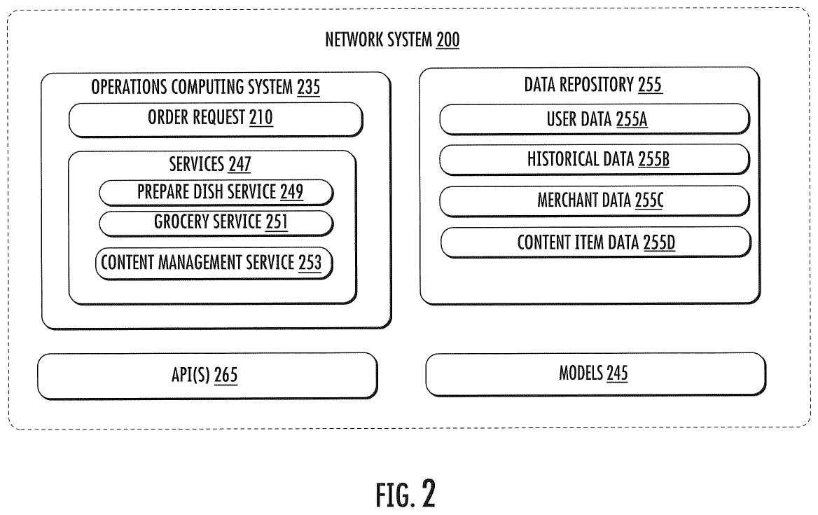

The computing systems of FIG. 1 can be utilized to facilitate food delivery service order requests, multimodal content feature extraction, action data structure generation, or action data structure execution. For example, the network system 130 can include various sub components such as services 147 or API(s) 165 which will be described in further detail with regard to FIG. 2.

FIG. 2 depicts a block diagram of an example network system 200. Network system 200 can include operations computing system 235, data repository 255, API(s) 265, or models 245. As described in FIG. 1, operations computing system can include order request 210 or services 247.

Services 247 can include backend computing services that are programmed to perform certain computing functions. The services 247 can be accessed via an API gateway that can route messages to the specific services based on the data encoded in the messages. The messages can be formatted based on one or more APIs, which can include instructions for a computing device (or software application) to request/report certain information.

The services 247 can include prepare dish service 249, grocery service 251, or content management service 253. Prepare dish service 249 can receive an order request 210 for a prepared comestible item. The order request 210 can include a request for one or more prepared menu items or can include one or more individual ingredients. In some instances, order request 210 can include non-comestible item such as utensils needed for preparing specific dishes. The order request 210 can be processed via an API gateway such that the information is encoded in messages which can be formatted such that receiving computing devices (or software applications) are able to decode and utilize such information. For instance, the information can include executable instructions which automatically trigger the initiation of actions or processing to be performed by the receiving computing device.

Operations computing system 235 can generate data indicative of the order request 210 or an action data structure associated with an order request. The data indicative of the order request 210 can include estimated time of departure, estimated time of arrival, estimated preparation time, real-time updates on order preparation, real-time updates on order location. The action data structure associated with the order request can be executed by network system 200 to initiate and facilitate completion of order request 210. The operations computing system 235 can provide data for display on a user device indicative of updates on the order request 210. For example, an update can include an update about what stage of delivery the order request 210 is in. The stage of delivery can include, for example, preparation, pick-up by courier, courier in route, approaching delivery, or delivered.

An operations computing system 235 associated with the service entity can receive an order request 210 from the user device. The operations computing system 235 can send a request to a courier device associated with a courier for the courier to perform the requested order request service. The courier can be associated with the vehicle.

The operations computing system 235 can communicate data indicative of the food delivery service assignment to a courier. For instance, the operations computing system 235 can send a request to the courier device of the courier. The request can be communicated to the courier via the software application running on the courier device associated with the courier. The request can include a request for the courier to accept the food delivery service assignment. Additionally, or alternatively, the operations computing system 235 can send a request to a vehicle device(s) (e.g., a tablet stored onboard the vehicle) of at least one vehicle. The request can be communicated to the courier via the software application running on a courier device.

The courier can provide user input to the courier device (e.g., via the software application) to accept or decline the vehicle service assignment. In some examples, user input can be provided directly into a service application. Additionally, or alternatively, user input can be provided via a third-party application. Data indicative of the acceptance or rejection of the request can be provided to the operations computing system 235.

The operations computing system 235 can communicate data indicative of the order request 210 via one or more services 247. Prepare dish service 249 can communicate data indicative of one or more items to be prepared by one or more merchants. The data indicative of the one or more items to be prepared can be received by one or more merchant device(s) via an application or API(s) on the device.

The operations computing system 235 can communicate data indicative of the order request 210 via grocery service 251. Grocery service 251 can communicate data indicative of one or more items to be shopped by a shopper at one or more merchants. For instance, the one or more merchants can include a grocery store or other store where individual ingredients can be purchased. The data indicative of the one or more items to be prepared can be received by one or more merchant device(s) via an application or API(s) on the device. In some implementations, grocery service 251 can communicate data indicative of one or more items to be shopped by a courier at one or more merchants. For instance, a courier can perform a shopping portion of an order and a delivery portion of an order.

Operations computing system 235 can include a content management service 253. Content management service 253 can help facilitate requests for content items to be provided for display via a user device. Content management service 253 can receive a request for a content item or can otherwise be called to select or rank one or more content items from content item data 255D to be transmitted to a user device. In some instances, content management service 253 can obtain context data associated with a current service application session on a user device. The content management service 253 can determine one or more content items to provide for display via the user device. Content items can include multimodal content items such as videos, images, audio, text, or other modes of expression.

Network system 200 can utilize one or more API(s) 265 to facilitate execution of action data structures for facilitating order requests by one or more of services 247. Network system 200 can utilize one or more API(s) 265 to facilitate communication between network system 200 and user devices to provide content items responsive to requests for content items.

Network system 200 can include data repository 255. Data repository can include user data 255A, historical data 255B, merchant data 255C, or content item data 255D.

User data 255A can include data associated with a user. User data 255A can include user preference data or other data that can be utilized by the operations computing system 235 to generate recommendations of content items or food items.

Historical data 255B can include data associated with a user, data associated with one or more merchants, data associated with one or more couriers, or data associated with content item interactions. Historical data can include information associated with users, merchants, couriers, or content items. For example, historical data can include a previous delivery service order request that indicates items, merchant locations, and feedback from a user. In some examples, historical data can include the history of specific grocery items, specific prepared items, or specific content items.

Merchant data 255C can include real-time data associated with merchants. For instance, merchant data 255C can include hours associated with a location, inventory, menu items, number of current order requests being processed, or any other relevant merchant data.

Content item data 255D can include data associated with one or more multimodal content items. In some instances, content item data 255D can include metadata associated with one or more content items. For instance, metadata can include categorization data, extracted feature data, creator information, time data, freshness data, performance data, or other data.

Categorization data can include a designation as a recipe video, an unboxing video, a delivery video, how the dish is made video, or some other category of video. As described herein, the category of the video can affect how the video or other multimodal content is processed by the computing system. For instance, a video that is categorized as a recipe video may be transcribed and the transcription can be used to determine individual ingredients, instructions for preparing a dish, or other useful information. Additionally, or alternatively, a video that is categorized as an unboxing video may be processed by an image processing model to determine the food item being delivered, a brand that is on the packaging, or other information that can help the computing system to provide recommendations relating to the delivered content.

Extracted feature data can include one or more ingredients or dishes extracted from the content item. In some instances, extracted feature data can include a recipe associated with a dish including quantities of ingredients or instructions for preparing a dish.

Creator information data can include a profile associated with the content item. For instance, an individual user or merchant can have a profile associated with the service application to generate or share content item such as videos.

Time data can include a date or time stamp associated with the creation or uploading of the content item. Freshness data can include an indication of whether the receiving user has seen the content item.

Performance data can include various metrics such as click through rates, impressions, interactions, or other data indicative of performance of the content item.

The content item data 255D can be utilized by the computing system to provide for selection and ranking of content items in order to provide for new discoverable content or provide for content that is likely to be engaged with by the user. In some instances, the computing system can preload a certain number of content items to prevent latency as the content items are scrolled or otherwise presented via a user interface of a user device.

Models 245 can include the models described in FIG. 3. FIG. 3 depicts a block diagram of example models 345. Models 345 can include multimodal processing model 350, cuisine categorization model 355, video recommendation model 360, or similar dish model 365. In some instances, the machine-learned model can include a multimodal processing model. For instance, the multimodal processing model can process input including a number of modalities. The multimodal processing model can perform a fusion of data from multimodalities such as audio, text, image, video, or any other modality. In some instances, combining information can include fusion-based approaches, alignment-based approaches, or later fusion to generate high-dimensional representations that capture semantic information associated with the data of each respective modality.

A fusion-based approach can provide for encoding different modalities of information into a common representation space such as a multi-dimensional embedding space. An example implementation of a fusion-based approach can include applications such as audio-visual speech recognition.

An alignment-based approach can provide for aligning different modalities such that the respective modalities can be directly compared. For instance, an alignment-based approach can include processing audio information and video information associated with an audio-visual content item and aligning the two to determine the subject of the audio-visual content.

A late fusion approach can involve combining the predictions from models trained on each respective modality separately. For instance, a late fusion approach can include processing data from each respective modality and then combining the individual predictions.

In some instances, multimodal processing models can include translation components. The translation components can provide for translating input data from a first modality to a second modality such that the data can be processed. Additionally, or alternatively, the methods can include co-learning which can provide for transferring knowledge learned by one model or associated with one modality to tasks involving other models or other modalities.

In some instances, multimodal processing can be performed with machine-learned models. By way of example, the machine-learned models can include a neural network. In some instances, the machine-learned model can include a generative model such as a large language model.

The models described herein are provided for exemplary purposes only and are not meant to be limited. Any of the above models can be models 345. In some instances, models 345 can be a single model. In some instances, models 345 can be distinct models. In some instances, the models 345 can be a combination of various kinds of machine-learned models with unique architecture and training methods. For instances, some models can be trained using supervised or unsupervised learning. In some instances, the models can be trained on delivery service specific training data. In some instances, the models can be trained based on comestible item content item specific training data to improve the extraction of comestible item features and dish data from the content items.

Multimodal processing model 350 can include one or more models capable of processing one or more modes of data. For instance, multimodal processing model 350 can process images, videos, text, or audio data to extract features associated with content items. The extracted features can be utilized by other models or components of the computing system to perform actions such as cuisine categorization, video recommendation, similar dish recommendation, generation of ingredients or recipes, deliverability status determination components, or any other models or components. For instance, the multimodal processing model 350 can process a video of a burrito bowl being made. The video can include a voice over describing the different ingredients added to the bowl such as rice, beans, chicken, salsa, cheese, and guacamole. The multimodal processing model 350 can process the image to determine the items that are being added, the order in which the items are added, or instructions for preparing any of the items.

Cuisine categorization model 355 can include a model that utilizes features extracted by the multimodal processing model 350 to determine a cuisine categorization for the dish that is determined to be in the content item. For instance, continuing the example from above, the computing system can determine based on the ingredients in the dish that the dish is likely Mexican cuisine. The cuisine categorization can be stored in a data repository (e.g., data repository 155 or data repository 255).

Video recommendation model 360 can include a model that utilizes features extracted from the video, cuisine categorization data, user data, or content item data to recommend one or more videos or other content items. For instance, the model can adjust recommendations based on session level data such as cuisines currently being browsed, historical data such as whether a user has ordered a particular cuisine, dish, or from a particular restaurant before. In some instances, video recommendation model 360 can provide output to recommend videos which have not been previously viewed or can select or rank videos of new cuisines higher than videos of cuisines that are frequently ordered by a user. Additionally, or alternatively, video recommendation model 360 can recommend content based on performance data associated with the content.

Similar dish model 365 can obtain feature data or cuisine categorization data to determine one or more similar dishes or items to those depicted in the content item. In some instances, a content item can provide an item which has been ordered.

In some implementations, the machine-learned models described herein can be trained at a training computing system and then provided for storage and/or implementation at one or more computing devices, as described above. For example, a model trainer can be located at the training computing system. The training computing system can be included in or separate from the one or more computing devices that implement the machine-learned model. In some implementations, the model can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

In some implementations, the model trainer can perform centralized training of the machine-learned models (e.g., based on a centrally stored dataset). In other implementations, decentralized training techniques such as distributed training, federated learning, or the like can be used to train, update, or personalize the machine-learned models.

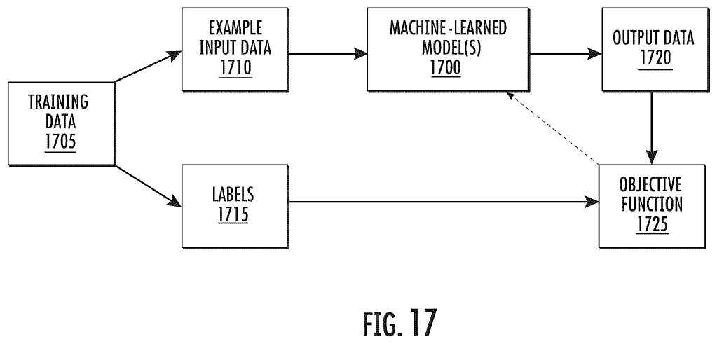

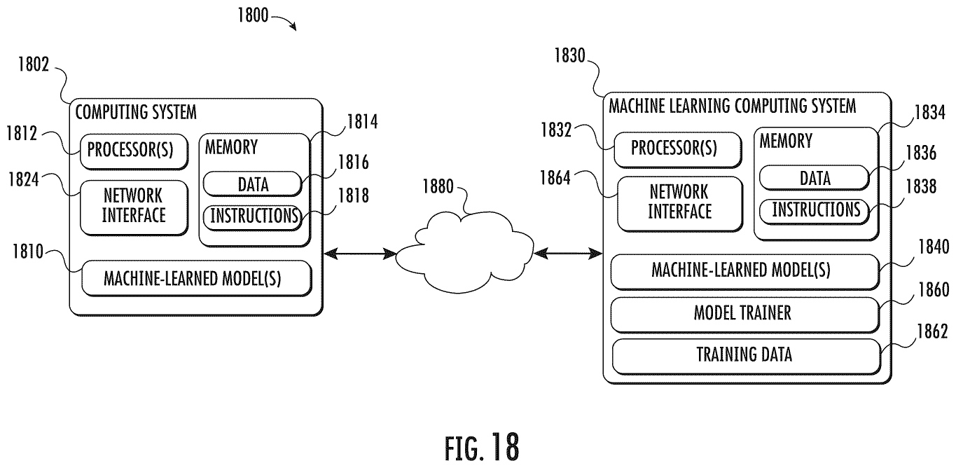

The machine-learned models described herein can be trained according to one or more of various different training types or techniques. For example, in some implementations, the machine-learned models can be trained using supervised learning, in which the machine-learned model is trained on a training dataset that includes instances or examples that have labels. The labels can be manually applied by experts, generated through crowd-sourcing, or provided by other techniques (e.g., by physics-based or complex mathematical models). In some implementations, if the user has provided consent, the training examples can be provided by the user computing device. In some implementations, this process can be referred to as personalizing the model. Training of the machine-learned models will be described in further detail in regard to FIGS. 17 and 18.

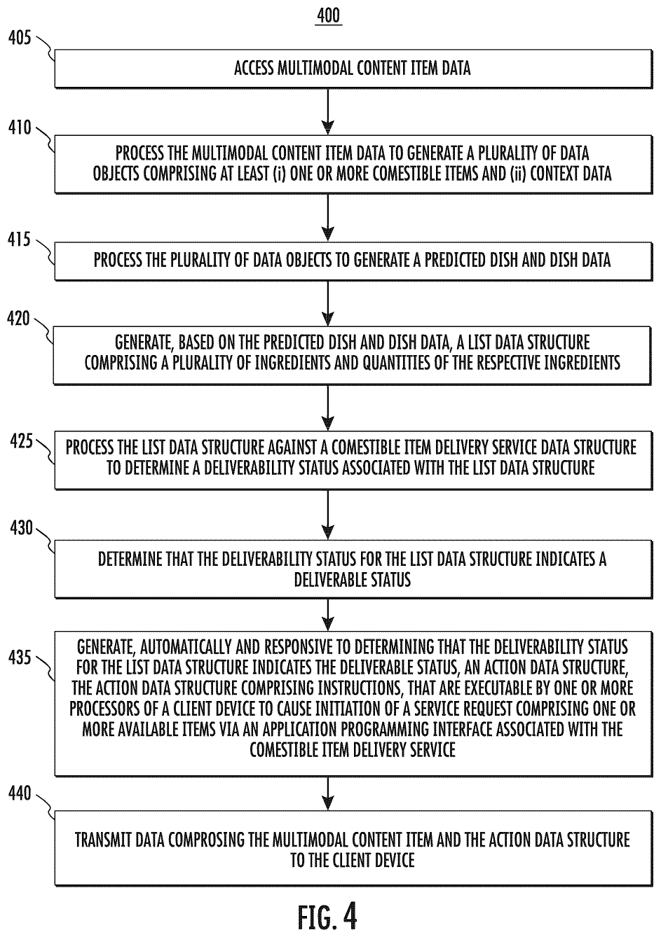

FIG. 4 depicts a flowchart diagram of an example method 400 to perform multimodal content feature extraction for action data structure generation and execution in accordance with some embodiments of the present disclosure. Method 400 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 400 can be performed by network computing system (e.g., network system 130, service entity computing system 1605) which can be a distributed computing system (e.g., cloud-based systems). FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 405, processing logic can access multimodal content item data. Multimodal content item data can include any form of content such as video, image, audio, text, or other mode of content. For instance, multimodal content item data can include a shortform video or longform video created by a user, merchant, courier, or the service entity computing system. In some instances, multimodal content items can be generated by a machine-learned model such as a generative machine-learned model.

An example can include a video of a burrito bowl being created. The video can include an individual adding a number of ingredients such as rice, beans, chicken, cheese, salsa, and guacamole to the dish. The video can include a voice over or some other form of narration of the items being added. Additionally, or alternatively, the video can include captions, a song overlay, or some other form of content.

Multimodal content items can be created by a variety of users. Users can include consumers who initiate service requests, merchants who prepare dishes associated with order requests, merchants who provide for shopping of items, couriers who provide for shopping of items, or couriers who provide for transportation of items. Multimedia content items can be generated on a user device such as a user device for a consumer, merchant device, or courier device. In some instances, these devices can include the devices depicted in FIG. 1.

By way of example, a consumer can generate a video that depicts: receiving items associated with an order, unboxing items associated with an order, or preparing a dish associated with a delivery. In some instances, a video could include tips or hacks associated with particular menu items of merchants. Such as combining certain dishes or sauces or adding in ingredients from home to alter the dish.

Merchants who prepare dishes can generate a video of a behind the scenes meal preparation of the kitchen, a day in the life of an employee, a packing video, or a handoff to a courier video. As such, the content can be menu item specific or be tailored to a merchant in general. The merchant generated content may include approaches for customizing the order. The customizations may include suggestions from the merchant or requests from a customer. For example, the merchant may generate content showing how a particular dish is prepared to be alternatively gluten free or to depict how the merchant handles gluten free food or other allergens to avoid cross contamination.

Merchants who provide shopping items can generate a video of current sale items or specials that are live, a “come shop with me” video showing a merchant fulfilling an order, a video showing tips on picking the best produce item, or a check out or “haul” video. Couriers who perform a shopping portion of a service request can generate similar content.

Couriers who provide transportation of items can generate a video of picking up or dropping off an order, a day in the life of a courier, or tips and tricks for navigating pick up or drop off at certain kinds of locations.

The multimedia content item can include video, audio, text overlay, or any other mode of information sharing. For instance, the multimedia content item can include a video which is embedded in a software application or is posted to a network where it can be viewed by other computing devices accessing the network and requesting multimedia content items for display. For instance, the network system can include a social network or some other form of network where multimedia content items can be generated, uploaded, shared, or viewed.

The content can be reviewed against any network rules or constraints. As such, multimedia content items which violate any network rules or constraints can be flagged for review or otherwise prevented from being shared or viewed via an application or API accessing the network. In some instances, the network system can generate a message indicating why the multimedia content item violates the network rules or constraints and provide suggestions for altering the multimedia content such that it can be uploaded, shared, or viewed.

At operation 410, processing logic can process the multimodal content item data to generate a plurality of data objects including at least (i) one or more comestible items and (ii) context data. The one or more comestible items can include one or more prepared menu items available from a merchant. The one or more comestible items can include one or more individual ingredients that are used in a dish or multi-course meal. As described herein, a merchant can include a restaurant, a grocery store, a convenience store, or any other store.

Context data can include metadata associated with the multimodal content item. For instance, metadata can include content item data (e.g., content item data 255D). For instance, content item data can include categorization data, extracted feature data, creator information, time data, freshness data, performance data, or other data. In some instances, context data can include data associated with a current service application session on a user device such as other content that has been viewed, menu items which have been viewed, merchant pages, or other current session data.

Turning back to the example, processing logic can process the video of the generation of the burrito bowl to determine the ingredients added to the burrito bowl or determine that the end result of the video is a burrito bowl containing certain ingredients. For instance, the processing logic can process individual frames of the video and perform image processing to determine what ingredients are present within the video. If the video includes a voice over, processing logic can generate a transcript and process the transcript to determine which ingredients are added, what order they are added, and in what quantity. In some instances, the video can include subtitles or some other form of text overlay. Processing logic can process the text overlay data to determine ingredients, instructions, or other information relevant to the content item. Additionally, information relating to the video can include information about the party that generated or posted the video, when the video was posted, whether the video is associated with a particular merchant, or any other relevant context data.

At operation 415, processing logic can process the plurality of data objects to generate a predicted dish and dish data. Dish data can include for the predicted dish including one or more ingredient quantities and directions for preparing the predicted dish. Dish data can include a recipe for a predicted dish. A recipe can include one or more ingredient quantities and directions for preparing the predicted dish. In some instances, a recipe can be generated by a machine-learned model based on the features extracted from the multimodal content item.

For instance, the recipe for the burrito bowl example could include a listing of the extracted comestible items such as rice, beans, chicken, cheese, salsa, and guacamole. The processing logic can provide quantities associated with the various comestible items. The data objects can be associated with specific product items available at merchants. In some instances, the data objects can include additional comestible items that can pair well or are similar to the comestible items extracted from the content item.

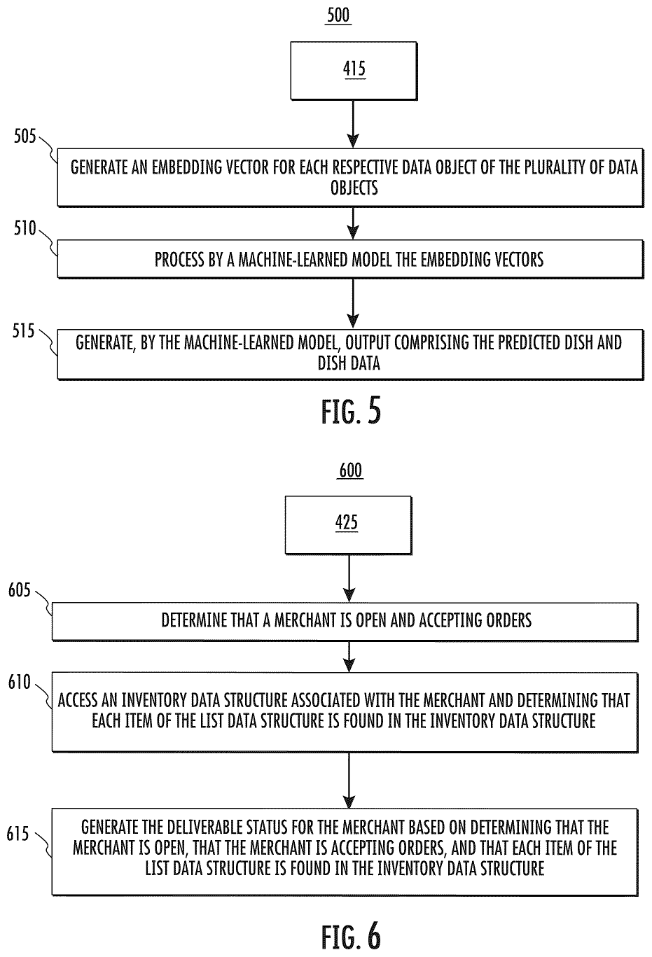

In some instances, processing the plurality of data objects to generate the predicted dish and dish data can be generated using a machine-learned model as depicted in FIG. 5.

In particular, FIG. 5 depicts a flowchart diagram of an example method 500 to perform multimodal content feature extraction for action data structure generation and execution in accordance with some embodiments of the present disclosure. In some instance method 500 can be sub steps of method 400. Method 500 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 500 can be performed by network computing system (e.g., network system 130, service entity computing system 1605) which can be a distributed computing system (e.g., cloud-based systems). FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 505, processing logic can generate an embedding vector for each respective data object of the plurality of data objects. For instance, the embedding vector can include a numerical representation of the respective data objects in an embedding space. The embedding vector can represent data object such as a word, token, image, user profile, or other relevant data. In some instances, the embedding space can include a high-dimensional space wherein similar data points are positioned closer to one another in the embedding space than dissimilar data points. In some instances, the embedding vectors can represent semantic relationships or contextual information associated with the data objects.

As an example, an embedding vector can include a numerical representation of an item or group of items associated with a dish or recipe. The embedding vector can be generated such that similar food items such as an apple and banana will be closer in the embedding space than an apple and a steak. The embedding vectors for the respective items can include a numerical representation of a variety of features associated with the items such as a category in a store they are associated with, whether the items are prepared at a restaurant or the ingredients need to be gathered and the end user prepares the dish, a cuisine associated with the items, or any other data associated with characteristics of the items. In some instances, an embedding vector can be generated for each respective modality of the multi-modal content. For instance, a first embedding vector can be generated for a visual portion of the content, a second embedding vector can be generated for an audio portion of the content, and a third embedding vector can be generated for a text or caption portion of the content. In some instances, the various modalities of content can have a number of embedding vectors associated with each respective modality.

At operation 510, processing logic can process, by a machine-learned model, the embedding vectors. The machine-learned model can obtain the embedding vectors as input and generate output. In some instances, the machine-learned model can be trained to perform a matching between a recipe or prepared dish and the feature data that has been extracted from the multimodal content item. Additionally, or alternatively, the machine-learned model or related systems can be trained to perform a lookup of a recipe database or prepared item database. The recipe database or prepared item database can include a number of recipes or prepared items and associated ingredients. As such, the system can compare ingredients indicated by the features extracted from the multimodal content items and determine relevant prepared items or recipes. Responsive to finding a match or close-match, the system can provide the associated prepared items or recipes as output. In some instances, the output generated can include an actionable data structure which can be processed by one or more API(s) to generate a cart or otherwise facilitate an in-application action for obtaining the items associated with the multimodal content item.

In some implementations, context data can be provided alongside the embedding vectors as input to the model. Context data can include metadata associated with the content item such as a user account associated with the item, a category of content, a cuisine type associated with the content, or any other relevant data. The context data can provide additional input to be processed by the machine-learned model to generate a better output including a recipe, ingredient list, or ingredient quantities. In some implementations, the machine-learned model can be trained on corpus of training data such as cookbooks, ingredient lists, food related videos, or other relevant data. By way of example, training data can include a list of ingredients and potential associated recipes. As such, the machine-learned model can be trained to predict, based on input including the ingredients extracted from the video, a recipe or prepared dish associated with the ingredients. In some instances, a machine-learned model can be a generative model that is tune for a particular recipe-generation based use case.

Additionally, the machine-learned model can be continually trained or tuned based on data obtained via user sessions. For instance, a user can provide feedback on the relevancy of a recommendation or predicted recipe. In some instances, the system can inferentially learn or otherwise create training data from user session data. For instance, if a user proceeds with accepting a recommendation, the system can tag the extracted feature data and the output data and update the training datastore to include the tagged data. As such, accepting a recommendations such as a prepared food item from a restaurant or a number of ingredients to be shopped and purchase from a grocery store can be indicative of the proposed ingredients, recipe, or dish be relevant to the multimodal content item which has been displayed via the application of the user device.

In some instances, the machine-learned model can include a generative model. For instance, the machine-learned model can include a diffusion model or transformer model, or any other model described herein (e.g., models 345). The machine-learned model can be trained to obtain embedding vectors indicative of multimodal content and generate predictions of recipes or ingredients. By way of example, a video content item can be processed to extract features such as a number of ingredients. The ingredients can be encoded into an embedding vector that can be processed by a multi-modal processing model, cuisine categorization model, video recommendation model, or similar dish model. For instance, based on ingredients extracted from a multimodal content item, the similar dish model can generate an output of one or more dishes with similar ingredients, a recipe for a dish that is predicted to be displayed within the multimodal content item, or recommended merchants with similar cuisine. As such, the machine-learned model can include a distribution of training data such that recipes or ingredients can be generated as output from the machine-learned model.

At operation 515, processing logic can generate, by the machine-learned model, output including the predicted dish and dish data. In some instances, the machine-learned model can include a neural network. In some instances, the machine-learned model can include a generative model. In some instances, the machine-learned model can include a generative adversarial network (GAN), variational autoencoder (VAE), autoregressive models, flow-based models, transformer-based models, or any other machine-learned models.

Turning back to FIG. 4, at operation 420, processing logic can generate, based on the predicted dish and dish data, a list data structure including a plurality of ingredients and quantities of the respective ingredients. Returning to the burrito bowl example from above, the list data structure can include [rice, 4 oz; beans, 4 oz; chicken, 4 oz; cheese, 1 oz; salsa, 2 oz; guacamole, 4 oz]. In some instances, the amount of the respective ingredients can be suggested by a generative model. Additionally, or alternatively, the amount of the respective ingredients can be provided by a party associated with the content item. For instance, if the content item is posted by a restaurant with the comestible items from the video available for order at the restaurant.

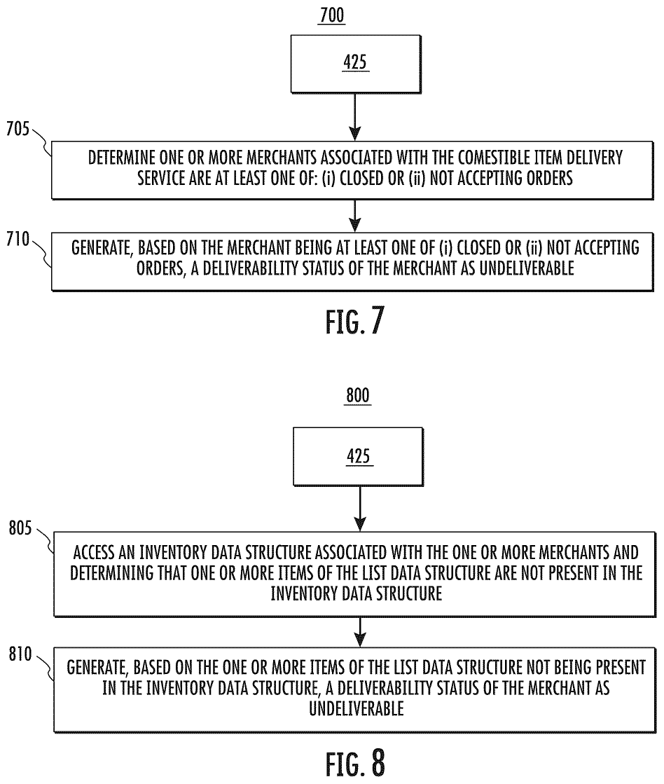

At operation 425, processing logic can process the list data structure against a comestible item delivery service data structure to determine a deliverability status associated with the list data structure. Determining the deliverability status associated with the list data structure can include performing the operations of FIG. 6, FIG. 7, or FIG. 8. For instance, processing the list data structure against a comestible item delivery service data structure to determine the deliverability status associated with the list data structure, can include, for each respective merchant of a plurality of candidate merchants, performing the operations depicted in FIG. 6.

FIG. 6 depicts a flowchart diagram of an example method 600 to perform multimodal content feature extraction for action data structure generation and execution in accordance with some embodiments of the present disclosure. In some instance method 600 can be sub steps of method 600. Method 600 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 600 can be performed by network computing system (e.g., network system 130, service entity computing system 1605) which can be a distributed computing system (e.g., cloud-based systems). FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 605, processing logic can determine that the merchant is open and accepting orders. For instance, processing logic can access data associated with a merchant including hours of operation and whether or not the merchant is accepting orders. In some instances, the merchant can communicate with the service computing system via one or more APIs. In some instances, a merchant can update a status associated with accepting orders. In some instances, a merchant can update a status associated with not accepting orders.

At operation 610, processing logic can access an inventory data structure associated with the merchant and determine that each item of the list data structure is found in the inventory data structure. For instance, the merchant can be a grocery store. The grocery store can maintain an inventory data structure which can be updated regularly. Additionally, or alternatively, the network computing system can maintain an inventory associated with plurality of merchants which can be updated based on existing or predicted orders (e.g., to make recommendations for replacement items, make recommendations for alternative merchants). Returning to the burrito bowl example, processing logic can compare the list data structure [rice, 4 oz; beans, 4 oz; chicken, 4 oz; cheese, 1 oz; salsa, 2 oz; guacamole, 4 oz] is within the inventory data structure for a particular merchant.

At operation 615, processing logic can generate the deliverable status for the merchant based on determining that the merchant is open, that the merchant is accepting orders, and that each item of the list data structure is found in the inventory data structure. In some instances, the deliverable status is indicative of the items in the list data structure being available and deliverable. In some implementations, the deliverability status includes at least one of: (i) a value, (ii) a flag, or (ii) a signal. For instance, a value can include a probability that an item or all the items in the list data structure are deliverable. A flag can include a visual or other indicator relating to the availability of the items for delivery. The signal can include data associated with the deliverability status such as an indicator for specific items which are not deliverable or may need to be sourced from an alternative merchant.

In some implementations, processing the list data structure against a comestible item delivery service data structure to determine the deliverability status associated with the list data structure, can include, for each respective merchant of a plurality of candidate merchants, performing the operations depicted in FIG. 7.

FIG. 7 depicts a flowchart diagram of an example method 700 to perform multimodal content feature extraction for action data structure generation and execution in accordance with some embodiments of the present disclosure. In some instance method 700 can be sub steps of method 700. Method 700 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 700 can be performed by network computing system (e.g., network system 130, service entity computing system 1605) which can be a distributed computing system (e.g., cloud-based systems). FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 705, processing logic can determine one or more merchants associated with the comestible item delivery service are at least one of: (i) closed or (ii) not accepting orders. For instance, processing logic can determine a merchant is closed based on available hours information. In some instances, processing logic can determine that a merchant is not accepting orders based on an API call returning information associated with the merchant not accepting orders or returning the call with an indication that the request cannot be completed.

At operation 710, processing logic can generate, based on the merchant being at least one of (i) closed or (ii) not accepting orders, a deliverability status of the merchant as undeliverable. For instance, an undeliverable status can indicate that merchant should not be included as a potential candidate merchant for fulfilling an order associated with the list data structure.

In some implementations, processing the list data structure against a comestible item delivery service data structure to determine the deliverability status associated with the list data structure, can include, for each respective merchant of a plurality of candidate merchants, performing the operations depicted in FIG. 7.

FIG. 8 depicts a flowchart diagram of an example method 800 to perform multimodal content feature extraction for action data structure generation and execution in accordance with some embodiments of the present disclosure. In some instance method 800 can be sub steps of method 800. Method 800 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 800 can be performed by network computing system (e.g., network system 130, service entity computing system 1605) which can be a distributed computing system (e.g., cloud-based systems). FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 805, processing logic can access an inventory data structure associated with the one or more merchants and determining that one or more items of the list data structure are not present in the inventory data structure. For instance, one of the ingredients in the recipe can be out of stock or otherwise not available at a particular merchant.

At operation 810, processing logic can generate, based on the one or more items of the list data structure not being present in the inventory data structure, a deliverability status of the merchant as undeliverable. As such, processing logic can determine that the merchant cannot facilitate fulfillment of the entire order. In some instances, processing logic can determine if there is one or more merchants that can fulfill the entire order. If there is not a single merchant that can fulfill the entire order, in some instances, the computing system can determine a combination of merchants to fulfill the order. As such, the computing system can determine that a list data structure is deliverable even if one single merchant is not determined to be deliverable.

Turning back to FIG. 4, at operation 430, processing logic can determine that the deliverability status for the list data structure indicates a deliverable status. For instance, the deliverable status can indicate that the items in the list data structure can be currently delivered to a user associated with an active service application session.

At operation 435, processing logic can generate, automatically and responsive to determining that the deliverability status for the list data structure indicates the deliverable status, an action data structure, the action data structure including instructions, that are executable by one or more processors of a client device to cause initiation of a service request including one or more available items via an application programming interface associated with the comestible item delivery service. The one or more available items can include the one or more comestible items generated from processing the multimodal content item data. As such, the available items can be items that are extracted from the multimodal content item and also located in the inventory data structure associated with one or more merchants.

In some implementations, the action data structure can include data such as the items and the quantities of the items. Additionally, the action data structure can include instructions, that when executed, cause a cart to be initiated and the items in the list data structure to be populated within the cart. In some instances, more than one action data structure can be generated. By way of example, a first action data structure can be generated for purchasing the individual ingredients and a second action data structure can be generated for purchasing a prepared dish. In some implementations, the different action data structures can be associated with different back-end software services. For instance, a first action data structure can be associated with a grocery back-end software services and the second action data structure can be associated with a restaurant delivery back-end software service. The back-end software services can manage data including inventory and item catalogs in different manners. For instance, a grocery delivery service can maintain inventory of thousands or millions of items for grocery stores whereas a restaurant delivery service can maintain inventory of tens or hundreds of items for restaurant merchants. Additionally, or alternatively, the first and action data structure can be executable by a single back-end software service which can facilitate both a grocery delivery service and a restaurant delivery service. These examples are exemplary only and not meant to be limiting.

At operation 440, processing logic can transmit data including the multimodal content item and the action data structure to the client device. As described herein, based on the items within the multimodal content item or similar items to those displayed in the multimodal content item being deliverable, the content item as well as the action data structure can be transmitted to a client device to be displayed. Upon interaction with the content item, the user can be directed to find similar items, order items associated with the multimodal content items or view additional content items.

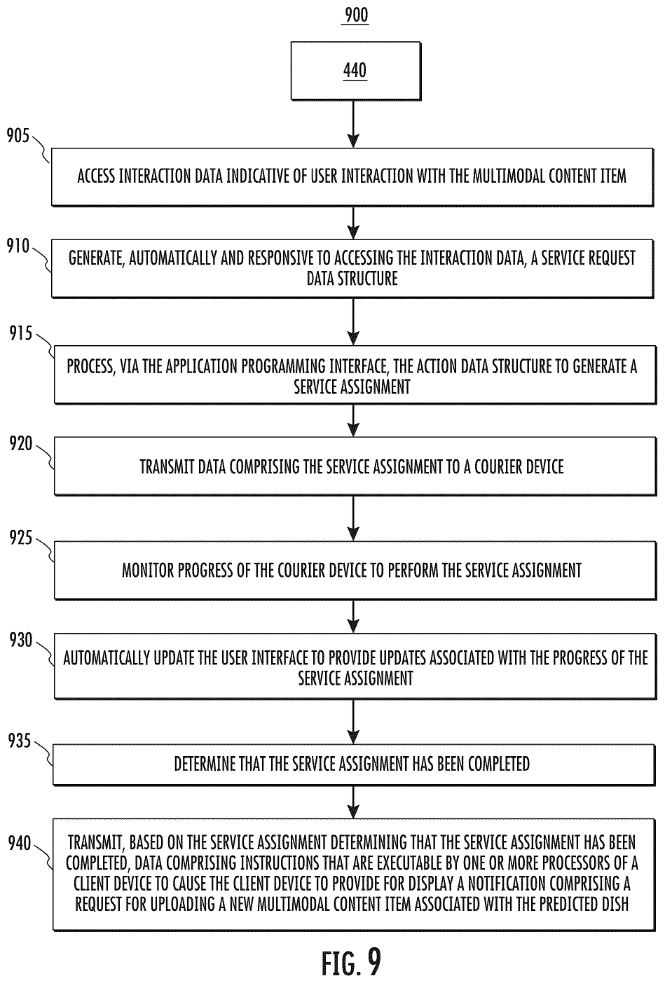

Additionally, or alternatively, method 400 can include additional steps. For instance, as described in FIG. 9, FIG. 9 depicts a flowchart diagram of an example method 900 to perform multimodal content feature extraction for action data structure generation and execution in accordance with some embodiments of the present disclosure. In some instances, method 800 can be sub steps of method 900. Method 900 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 900 can be performed by network computing system (e.g., network system 130, service entity computing system 1605) which can be a distributed computing system (e.g., cloud-based systems). FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 905, processing logic can access interaction data indicative of user interaction with the multimodal content item. For instance, data indicative of user interaction can include selection of a selectable user interface component. The selectable user interface component can include, for example, a button to “order now,” “find similar items,” or some similar prompt.

At operation 910, processing logic can generate, automatically and responsive to accessing the interaction data, a service request data structure. For instance, as described herein, selection of the selectable user interface component can cause the action data structure to be executed to generate a service request data structure. In some instances, the service request data structure can include a number of items, quantity of items, and merchant.

At operation 915, processing logic can process, via the application programming interface, the action data structure to generate a service assignment. As described herein, the action data structure can be executed via the API to generate the service assignment. The service assignment can include a merchant, a drop off location, a number of items, and quantities of the respective items.

At operation 920, processing logic can transmit data including the service assignment to a courier device. In some instances, the courier can perform both a shopping and transportation portion of the service assignment. In some instances, the courier can perform a transportation portion of the service assignment. In such cases, processing logic can transmit data including the service assignment to a merchant device such that the service assignment can be fulfilled by a combination of a merchant shopper and a courier.

At operation 925, processing logic can monitor progress of the courier device to perform the service assignment. For instance, processing logic can access location determining hardware of courier device to determine an estimated time of arrival to a merchant location. The processing logic can determine an estimated time of arrival to a drop-off location.

At operation 930, processing logic can automatically update the user interface to provide updates associated with the progress of the service assignment. For instance, the updates can include indications of a status of the service assignment. The status can include, for example, preparation, pick-up by courier, courier in route, approaching delivery, delivered, or any other status.

At operation 935, processing logic can determine that the service assignment has been completed. By way of example, processing logic can determine, based on location determining hardware associated with a courier device that the courier device has arrived at the drop-off location. Additionally, or alternatively, processing logic can obtain data indicative of the drop-off being completed. For instance, a courier or a user can provide an indication that the service assignment has been completed.

At operation 940, processing logic can transmit, based on determining that the service assignment has been completed, data including instructions that are executable by one or more processors of a client device to cause the client device to provide for display a notification including a request for uploading a new multimodal content item associated with the predicted dish. For instance, the notification can include a message indicating that the user can record and upload a multimodal content item associated with the predicted dish. By way of example, the multimodal content item can be a preparation video, an unboxing video, a rating video, or some other video relating to the original multimodal content item.

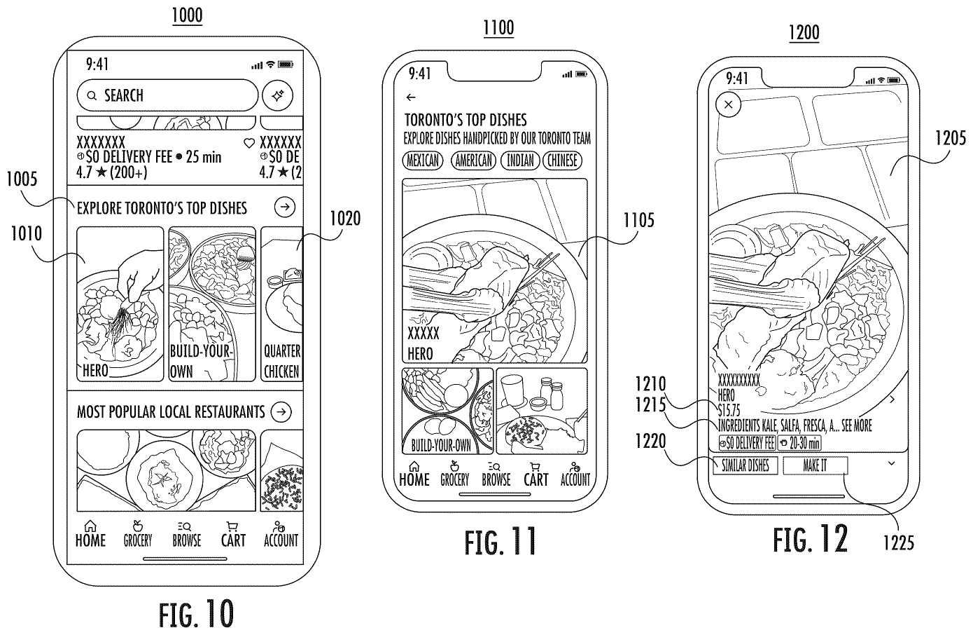

FIG. 10 to FIG. 14 depict example graphical user interfaces according to example embodiments of the present disclosure. FIG. 10 depicts example graphical user interface 1000. The graphical user interface 1000 can include an explore section 1005. Graphical user interface 1000 can include a number of content items. The content items can include a first content item 1010, a second content item 1015, and a third content item 1020. Each content item can be associated with either a premade meal or a grocery item list. In some instances, the content items can be provided for display via an application carousel.

FIG. 11 depicts example graphical user interface 1100. Example graphical user interface 1100 can include a first content item 1105. Graphical user interface 1100 depicts an additional alternative presentation of content items via bounding boxes of varying dimensions. For instance, a number of content items can be viewed concurrently. Additionally, or alternatively, the computing system can provide for thumbnails or other statis images, while selecting a single video to play at a time. As such, as a user scrolls, different content items can play versus being a static image.

FIG. 12 depicts example graphical user interface 1200. Example graphical user interface 1200 can include a content item 1205, a price for purchasing the item 1210, a listing of ingredients 1215, a selectable user interface element 1220 to launch a search page to show similar dishes. For instance, the selectable user interface element 1220 can be associated with an executable action data structure for initiating and order for the same or similar dish as depicted in the content item. As described herein, processing logic can process the content item 1205 to generate the listing of ingredients 1215 as well as determining a price for purchasing the item 1210 and a selectable user interface element 1220 to launch a search page to show similar dishes or to show the exact dish for purchase.

Additionally, or alternatively, example graphical user interface 1200 can include a selectable user interface element 1225 to launch a search page to show a plurality of ingredients associated with creation of the item within the content item. In some instances, selection of selectable user interface element 1225 can initiate execution of an action data structure to initiate a grocery delivery order. For instance, selection of selectable user interface element 1225 can initiate processing of the action data structure by an order API. The API can initiate creation of a cart or other order including the ingredients extracted from the content item 1205.

For instance, FIG. 12 can provide a video content item associated with a dish being created at a restaurant. The dish can be a salad with kale, salsa fresca, avocado, broccoli, and salmon. The ingredients associated with the dish can be extracted and provided for display as the listing of ingredients 1215 within graphical user interface 1200.

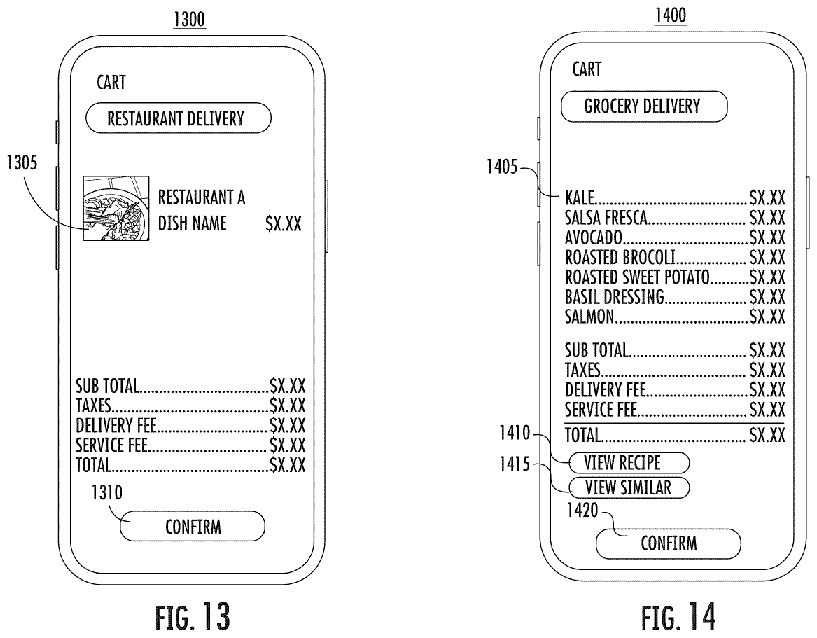

FIG. 13 depicts an example graphical user interface 1300. Example graphical user interface 1300 can include a dish 1305 that was depicted in the content item. In some instances, example graphical user interface 1300 can include a cart which can be generated by executing an action data structure which populates a cart for an item depicted in the content item or an item similar to that which was depicted in the content item. For instance, graphical user interface 1300 can depict a cart including the item that was depicted in content item (e.g., content item 1205) from the restaurant associated with the content item. Example graphical user interface 1300 can include a selectable user interface element 1310 to confirm the purchase.

FIG. 14 depicts an example graphical user interface 1400. Example graphical user interface 1400 can include a plurality of items associated with the content item. For instance, example graphical user interface 1400 can include a cart which can be generated by executing an action data structure which populates a cart for each ingredient 1405 for an item depicted in the content item (e.g., content item 1205). Example graphical user interface 1400 can additionally, or alternatively, include one or more selectable user interface elements. Such as selectable user interface element 1410, selectable user interface element 1415, or selectable user interface element 1420. Selectable user interface element 1410 can be selected to provide a recipe for the comestible item depicted in the content item. Selectable user interface element 1415 can be selected to provide alternative ingredients or recipes that are similar to that of the primary comestible item depicted in the content item.

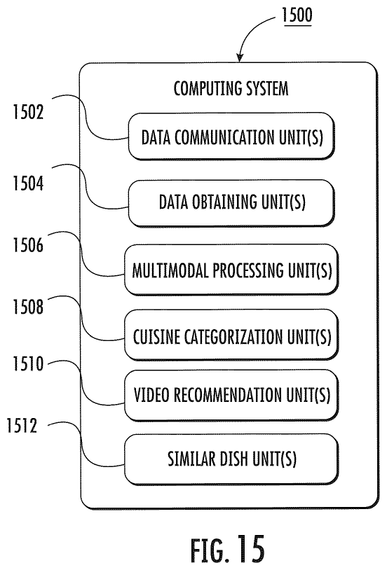

Various means can be configured to perform the methods and processes described herein. For example, FIG. 15 depicts an example computing system 1500 that includes various means according to example embodiments of the present disclosure. The computing system 1500 can be and/or otherwise include, for example, an operations computing system, etc. The computing system 1500 can include data communication unit(s) 1502, data obtaining unit(s) 1504, multimodal processing unit(s) 1506, cuisine categorization unit(s) 1508, video recommendation unit(s) 1510, similar dish unit(s) 1512, and/or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data communication unit(s) 1502) can be configured to communicate data indicative of a request for a courier to perform a delivery service associated with a delivery service request.

In addition, the means (e.g., data obtaining unit(s) 1504) can be configured to obtain data associated with a delivery service request. For example, delivery service request can be indicative of a pick-up location, merchant, item, and/or drop-off location associated with a delivery service request. In addition, in some implementations, the means (e.g., the data obtaining unit(s) 1504) can obtain data associated with one or more couriers, one or more merchants, and/or map data indicative of one or more geographic areas.

In addition, the means (e.g., multimodal processing unit(s) 1506) can be configured to extract feature data associated with the content such as ingredients, a recipe, and the like.

In addition, the means (e.g., cuisine categorization unit(s) 1508) can be configured to determine a cuisine categorization for one or more ingredients, recipe, or comestible item.

In addition, the means (e.g., video recommendation unit(s) 1510) can be configured to determine one or more recommended videos.

In addition, the means (e.g., similar dish unit(s) 1512) can be configured to determine one or more similar dishes.

These described functions of the means are provided as examples and are not meant to be limiting. The means can be configured for performing any of the operations and functions described herein.

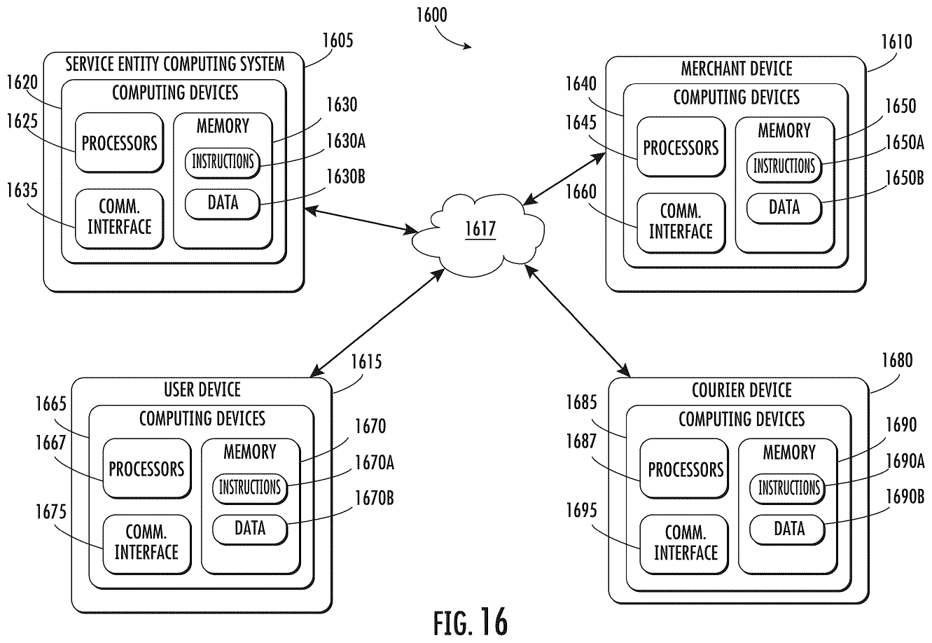

FIG. 16 depicts a block diagram of an example computing system 1600 for implementing systems and methods according to example embodiments of the present disclosure. The example computing system 1600 illustrated in FIG. 16 is provided as an example only. The components, systems, connections, and/or other aspects illustrated in FIG. 16 are optional and are provided as examples of what is possible, but not required, to implement the present disclosure. The example computing system 1600 can include a service entity computing system 1605 (e.g., that is associated with a delivery service entity). The example computing system 1600 can include one or more merchant devices 1610 (e.g., that is associated with a merchant). The example computing system 1600 can include one or more user devices 1615 (e.g., user device of the user, user device of the operator, user device of the vehicle). The example computing system 1600 can include one or more courier devices (e.g., a display device positioned on the exterior of a vehicle). One or more of the service entity computing system 1605, the merchant device 1610, the user device 1615, or the courier device can be communicatively coupled to one another over one or more communication network(s) 1617. The networks 1617 can correspond to any of the networks described herein.

The computing device(s) 1620 of the service entity computing system 1605 can include processor(s) 1625 and a memory 1630. The one or more processors 1625 can be any suitable processing device (e.g., a processor core, a microprocessor, an ASIC, a FPGA, a controller, a microcontroller) and can be one processor or a plurality of processors that are operatively connected. The memory 1630 can include one or more non-transitory computer-readable storage media, such as RAM, ROM, EEPROM, EPROM, one or more memory devices, flash memory devices, data registrar, etc., and combinations thereof.

The memory 1630 can store information that can be accessed by the one or more processors 1625. For example, the memory 1630 (e.g., one or more non-transitory computer-readable storage mediums, memory devices) can include computer-readable instructions 1630A that can be executed by the one or more processors 1625. The instructions 1630A can be software written in any suitable programming language or can be implemented in hardware. Additionally, or alternatively, the instructions 1630A can be executed in logically and/or virtually separate threads on processor(s) 1625.

For example, the memory 1630 can store instructions 1630A that when executed by the one or more processors 1625 cause the one or more processors 1625 (the service entity computing system 1605) to perform operations such as any of the operations and functions of the computing system(s) (e.g., operations computing system) described herein (or for which the computing system(s) are configured), one or more of the operations and functions for communicating between the computing systems, one or more portions/operations of method 900, and/or one or more of the other operations and functions of the computing systems described herein.

The memory 1630 can store data 1630B that can be obtained (e.g., acquired, received, retrieved, accessed, created, stored). The data 1630B can include, for example, any of the data/information described herein. In some implementations, the computing device(s) 1320 can obtain data from one or more memories that are remote from the service entity computing system 1605.

The computing device(s) 1620 can also include a communication interface 1635 used to communicate with one or more other system(s) remote from the service entity computing system 1605, such as merchant device 1610, user device 1615, and/or courier device 1680. The communication interface 1635 can include any circuits, components, software, etc. for communicating via one or more networks (e.g., network(s) 1617). The communication interface 1635 can include, for example, one or more of a communications controller, receiver, transceiver, transmitter, port, conductors, software and/or hardware for communicating data.

The merchant device 1610 can include one or more computing device(s) 1640 that are remote from the service entity computing system 1605, the user device 1615, and the courier device 1680. The computing device(s) 1640 can include one or more processors 1645 and a memory 1650. The one or more processors 1645 can be any suitable processing device (e.g., a processor core, a microprocessor, an ASIC, a FPGA, a controller, a microcontroller) and can be one processor or a plurality of processors that are operatively connected. The memory 1650 can include one or more tangible, non-transitory computer-readable storage media, such as RAM, ROM, EEPROM, EPROM, one or more memory devices, flash memory devices, data registrar, etc., and combinations thereof.

The memory 1650 can store information that can be accessed by the one or more processors 1645. For example, the memory 1650 (e.g., one or more tangible, non-transitory computer-readable storage media, one or more memory devices) can include computer-readable instructions 1650A that can be executed by the one or more processors 1645. The instructions 1650A can be software written in any suitable programming language or can be implemented in hardware. Additionally, or alternatively, the instructions 1650A can be executed in logically and/or virtually separate threads on processor(s) 1645.

For example, the memory 1650 can store instructions 1650A that when executed by the one or more processors 1645 cause the one or more processors 1645 to perform operations such as any of the operations and functions of the computing system(s) (e.g., merchant server) described herein (or for which the computing system(s) are configured), one or more of the operations and functions for communicating between computing systems, one or more portions/operations of method 400-900, and/or one or more of the other operations and functions of the computing systems described herein. The memory 1650 can store data 1650B that can be obtained. The data 1650B can include, for example, any of the data/information described herein.

The computing device(s) 1640 can also include a communication interface 1660 used to communicate with one or more system(s) that are remote from the merchant device 1610. The communication interface 1660 can include any circuits, components, software, etc. for communicating via one or more networks (e.g., network(s) 1617). The communication interface 1660 can include, for example, one or more of a communications controller, receiver, transceiver, transmitter, port, conductors, software and/or hardware for communicating data.

The user device 1615 can include one or more computing device(s) 1665 that are remote from the service entity computing system 1605, the merchant device 1610, and the courier device 1680. The computing device(s) 1665 can include one or more processors 1667 and a memory 1670. The one or more processors 1667 can be any suitable processing device (e.g., a processor core, a microprocessor, an ASIC, a FPGA, a controller, a microcontroller) and can be one processor or a plurality of processors that are operatively connected. The memory 1670 can include one or more tangible, non-transitory computer-readable storage media, such as RAM, ROM, EEPROM, EPROM, one or more memory devices, flash memory devices, data registrar, etc., and combinations thereof.

The memory 1670 can store information that can be accessed by the one or more processors 1667. For example, the memory 1670 (e.g., one or more tangible, non-transitory computer-readable storage media, one or more memory devices) can include computer-readable instructions 1670A that can be executed by the one or more processors 1667. The instructions 1670A can be software written in any suitable programming language or can be implemented in hardware. Additionally, or alternatively, the instructions 1670A can be executed in logically and/or virtually separate threads on processor(s) 1667.

For example, the memory 1670 can store instructions 1670A that when executed by the one or more processors 1667 cause the one or more processors 1667 to perform operations such as any of the operations and functions of the computing system(s) (e.g., user devices) described herein (or for which the user device(s) are configured), one or more of the operations and functions for communicating between systems, one or more portions/operations of method 400-900, and/or one or more of the other operations and functions of the computing systems described herein. The memory 1670 can store data 1670B that can be obtained. The data 1670B can include, for example, any of the data/information described herein.

The computing device(s) 1665 can also include a communication interface 1675 used to communicate computing device/system that is remote from the user device 1615, such as merchant device 1610, service entity computing system 1605, or courier device 1680. The communication interface 1675 can include any circuits, components, software, etc. for communicating via one or more networks (e.g., network(s) 1617). The communication interface 1675 can include, for example, one or more of a communications controller, receiver, transceiver, transmitter, port, conductors, software and/or hardware for communicating data.

The computing device(s) 1685 of the courier device 1680 can include processor(s) 1687 and a memory 1690. The one or more processors 1687 can be any suitable processing device (e.g., a processor core, a microprocessor, an ASIC, a FPGA, a controller, a microcontroller) and can be one processor or a plurality of processors that are operatively connected. The memory 1690 can include one or more non-transitory computer-readable storage media, such as RAM, ROM, EEPROM, EPROM, one or more memory devices, flash memory devices, data registrar, etc., and combinations thereof.

The memory 1690 can store information that can be accessed by the one or more processors 1687. For example, the memory 1690 (e.g., one or more non-transitory computer-readable storage mediums, memory devices) can include computer-readable instructions 1690A that can be executed by the one or more processors 1687. The instructions 1690A can be software written in any suitable programming language or can be implemented in hardware. Additionally, or alternatively, the instructions 1690A can be executed in logically and/or virtually separate threads on processor(s) 1687.

For example, the memory 1690 can store instructions 1690A that when executed by the one or more processors 1687 cause the one or more processors 1687 (the courier device 1680) to perform operations such as any of the operations and functions of the display device(s) described herein (or for which such devices are configured), one or more of the operations and functions for communicating between the computing systems/devices, one or more portions/operations of method 900, and/or one or more of the other operations and functions of the computing systems described herein.

The memory 1690 can store data 1690B that can be obtained (e.g., acquired, received, retrieved, accessed, created, stored). The data 1690B can include, for example, any of the data/information described herein. In some implementations, the computing device(s) 1685 can obtain data from one or more memories that are remote from the courier device 1680.

The computing device(s) 1685 can also include a communication interface 1695 used to communicate with one or more other system(s) remote from the courier device 1680, such as merchant device 1610, user device 1615, and/or service entity computing system 1605. The communication interface 1695 can include any circuits, components, software, etc. for communicating via one or more networks (e.g., network(s) 1617). The communication interface 1695 can include, for example, one or more of a communications controller, receiver, transceiver, transmitter, port, conductors, software and/or hardware for communicating data.

The network(s) 1617 can be any type of network or combination of networks that allows for communication between devices. In some implementations, the network(s) 1617 can include one or more of a local area network, wide area network, the Internet, secure network, cellular network, mesh network, peer-to-peer communication link and/or some combination thereof and can include any number of wired or wireless links. Communication over the network(s) 1617 can be accomplished, for example, via a communication interface using any type of protocol, protection scheme, encoding, format, packaging, etc.

FIG. 17 illustrates a block diagram of an example training process in which a machine-learned model 1700 is trained on training data 1705 that includes example input data 1710 that has labels 1715. Training processes other than the example process depicted in FIG. 17 can be used as well.

In some implementations, training data 1705 can include examples of the input data 1710 that have been assigned labels 1715 that correspond to the output data 1720. For example, extracting features from multimodal content items can be performed using a multimodal processing model that is trained using multimodal content training data gathered by the computing system. This multimodal content training data can include data associated with content items. The data associated with the content items can include metadata such as include categorization data, extracted feature data, creator information, time data, freshness data, or performance data.

In some implementations, during training, the input training data can be intentionally deformed in any number of ways to increase model robustness, generalization, or other qualities. Example techniques to deform the training data include adding noise; changing color, shade, or hue; magnification; segmentation; amplification; etc.

In some implementations, the machine-learned model 1700 can be trained by optimizing an objective function 1725. For example, in some implementations, the objective function 1725 can be or include a loss function that compares (e.g., determines a difference between) output data generated by the model from the training data 1705 and labels 1715 (e.g., ground-truth labels) associated with the training data 1705. For example, the loss function can evaluate a sum or mean of squared differences between the output data and the labels. As another example, the objective function 1725 can be or include a cost function that describes a cost of a certain outcome or output data 1720. Other objective functions can include margin-based techniques such as, for example, triplet loss or maximum-margin training.

One or more of various optimization techniques can be performed to optimize the objective function 1725. For example, the optimization technique(s) can minimize or maximize the objective function 1725. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some implementations, backward propagation of errors can be used in conjunction with an optimization technique (e.g., gradient based techniques) to train a model (e.g., a multi-layer model such as an artificial neural network). For example, an iterative cycle of propagation and model parameter (e.g., weights) update can be performed to train the model. Example backpropagation techniques include truncated backpropagation through time, Levenberg-Marquardt backpropagation, etc.

In some implementations, the machine-learned models described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

In some implementations, the machine-learned models described herein can be trained using semi-supervised techniques which combine aspects of supervised learning and unsupervised learning.

In some implementations, the machine-learned models described herein can be trained or otherwise generated through evolutionary techniques or genetic algorithms.

In some implementations, the machine-learned models described herein can be trained using reinforcement learning. In reinforcement learning, an agent (e.g., model) can take actions in an environment and learn to maximize rewards or minimize penalties that result from such actions. Reinforcement learning can differ from the supervised learning problem in that correct input/output pairs are not presented, nor sub-optimal actions explicitly corrected.

In some implementations, one or more generalization techniques can be performed during training to improve the generalization of the machine-learned model. Generalization techniques can help reduce overfitting of the machine-learned model to the training data. Example generalization techniques include dropout techniques; weight decay techniques; batch normalization; early stopping; subset selection; stepwise selection; etc.

In some implementations, the machine-learned models described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search); gradient-based optimization; etc. Example techniques or tools for performing automatic hyperparameter optimization include Hyperopt; Auto-WEKA; Spearmint; Metric Optimization Engine (MOE); etc.

In some implementations, various techniques can be used to optimize or adapt the learning rate when the model is trained. Example techniques or tools for performing learning rate optimization or adaptation include Adagrad; Adaptive Moment Estimation (ADAM); Adadelta; RMSprop; etc.

In some implementations, transfer learning techniques can be used to provide an initial model from which to begin training of the machine-learned models described herein.

FIG. 18 depicts a block diagram of an example computing system 1800 according to example embodiments of the present disclosure. The example system 1800 includes a computing system 1802 and a machine learning computing system 1830 that are communicatively coupled over a network 1880.

In some implementations, the computing system 1802 can generate recommended items such as prepared items or recipes of items. In some implementations, the computing system 1802 can be included in a device associated with a food delivery service entity. In some instances, the computing system 1802 can operate offline to perform dynamic suggestions prepared items or recipes and ingredient lists to provide order suggestions to a user. The computing system 1802 can include one or more distinct physical computing devices.

The computing system 1802 includes one or more processors 1812 and a memory 1814. The one or more processors 1812 can be any suitable processing device (e.g., a processor core, a microprocessor, an ASIC, a FPGA, a controller, a microcontroller) and can be one processor or a plurality of processors that are operatively connected. The memory 1814 can include one or more non-transitory computer-readable storage media, such as RAM, ROM, EEPROM, EPROM, one or more memory devices, flash memory devices, etc., and combinations thereof.

The memory 1814 can store information that can be accessed by the one or more processors 1812. For instance, the memory 1814 (e.g., one or more non-transitory computer-readable storage mediums, memory devices) can store data 1816 that can be obtained, received, accessed, written, manipulated, created, or stored. The data 1816 can include, for instance, user data, historical data, merchant data or content item data. In addition, or alternatively the data 1816 can include, for instance data associated with a number of content items, prepared items, or recipes and ingredient lists.

In some implementations, the computing system 1802 can obtain data from one or more memory device(s) that are remote from the system 1802.

The memory 1814 can also store computer-readable instructions 1818 that can be executed by the one or more processors 1812. The instructions 1818 can be software written in any suitable programming language or can be implemented in hardware. Additionally, or alternatively, the instructions 1818 can be executed in logically or virtually separate threads on processor(s) 1812.

For example, the memory 1814 can store instructions 1818 that when executed by the one or more processors 1812 cause the one or more processors 1812 to perform any of the operations or functions described herein, including, for example, operations depicted in FIG. 4 to FIG. 9.

According to an aspect of the present disclosure, the computing system 1802 can store or include one or more machine-learned models 1810. As examples, the machine-learned models 1810 can be or can otherwise include various machine-learned models such as, for example, neural networks (e.g., deep neural networks), support vector machines, decision trees, ensemble models, k-nearest neighbors models, Bayesian networks, or other types of models including linear models or non-linear models. Example neural networks include feed-forward neural networks, convolutional neural networks, recurrent neural networks (e.g., long short-term memory recurrent neural networks), or other forms of neural networks.

In some implementations, the computing system 1802 can receive the one or more machine-learned models 1810 from the machine learning computing system 1830 over network 1880 and can store the one or more machine-learned models 1810 in the memory 1814. The computing system 1802 can then use or otherwise implement the one or more machine-learned models 1810 (e.g., by processor(s) 1812). In particular, the computing system 1802 can implement the machine-learned model(s) 1810 to perform merchant ranking or fulfillment cost prediction. For example, in some implementations, the computing system 1802 can employ the machine-learned model(s) 1810 by inputting multiple time frames of multimodal data such as image, audio, or text data into the machine-learned model(s) 1810 and receiving output data such as prepared items or recipes as an output of the machine-learned model(s) 1810.

The machine learning computing system 1830 includes one or more processors 1832 and a memory 1834. The one or more processors 1832 can be any suitable processing device (e.g., a processor core, a microprocessor, an ASIC, a FPGA, a controller, a microcontroller) and can be one processor or a plurality of processors that are operatively connected. The memory 1834 can include one or more non-transitory computer-readable storage media, such as RAM, ROM, EEPROM, EPROM, one or more memory devices, flash memory devices, etc., and combinations thereof.

The memory 1834 can store information that can be accessed by the one or more processors 1832. For instance, the memory 1834 (e.g., one or more non-transitory computer-readable storage mediums, memory devices) can store data 1836 that can be obtained, received, accessed, written, manipulated, created, or stored. The data 1836 can include, for instance, user data, historical data, merchant data or content item data. In addition, or alternatively the data 1836 can include, for instance data associated with a number of content items, prepared items, or recipes and ingredient lists. In some implementations, the machine learning computing system 1830 can obtain data from one or more memory device(s) that are remote from the system 1830.

The memory 1834 can also store computer-readable instructions 1838 that can be executed by the one or more processors 1832. The instructions 1838 can be software written in any suitable programming language or can be implemented in hardware. Additionally, or alternatively, the instructions 1838 can be executed in logically or virtually separate threads on processor(s) 1832.

For example, the memory 1834 can store instructions 1838 that when executed by the one or more processors 1832 cause the one or more processors 1832 to perform any of the operations or functions described herein, including, for example, the operations depicted in FIG. 4 to FIG. 9.

In some implementations, the machine learning computing system 1830 includes one or more server computing devices. If the machine learning computing system 1830 includes multiple server computing devices, such server computing devices can operate according to various computing architectures, including, for example, sequential computing architectures, parallel computing architectures, or some combination thereof.

In addition, or alternatively to the model(s) 1810 at the computing system 1802, the machine learning computing system 1830 can include one or more machine-learned models 1840. As examples, the machine-learned models 1840 can be or can otherwise include various machine-learned models such as, for example, neural networks (e.g., deep neural networks), support vector machines, decision trees, ensemble models, k-nearest neighbors models, Bayesian networks, or other types of models including linear models or non-linear models. Example neural networks include feed-forward neural networks, convolutional neural networks, recurrent neural networks (e.g., long short-term memory recurrent neural networks), generative neural networks, or other forms of neural networks.

By way of example, the machine-learned model can include a generative adversarial network (GAN), variational autoencoder (VAE), autoregressive models, flow-based models, transformer-based models, or any other machine-learned models.

Generative adversarial networks (GANs) can be a type of deep learning model that uses two neural networks including a generator and a discriminator. The generator can create data that tries to mimic real data while the discriminator attempts to distinguish between the real and generated data. By training the generator and discriminator against each other, GANs can generate realistic data.

Variational autoencoders (VAEs) can encode input data into a latent space. A latent space can include a lower-dimensional representation, compact representation of the data. The latent space can be decoded into the original data. By learning the distribution of the latent space, VAEs can generate new data by sampling from the distribution and decoding the samples.

Autoregressive models can generate data sequentially, one element at a time. The autoregressive models can predict a next element in a sequence based on the previously generated elements. As such, the autoregressive models can capture complex dependencies within the data and can be utilized in various applications such as text generation or image synthesis.

Flow-based models can use invertible functions to transform data from a simple distribution to a complex distribution. As such, flow-based models can generate high quality samples efficiently and can learn underlying data distributions accurately. In some instances, flow-based models can be used to generate training data for machine-learned models. Some applications of flow-based models can include image generation, audio synthesis, or natural language generation.

Transformer-based models can be a type of neural network architecture that is good for natural language processing. Transformer-based models can utilize self-attention to process input sequences which can allow the models to utilize the context of the input including long-range dependencies and relationships within the input data. As such, transformer-based models can be utilized for summarization, translation, question answering, or other relevant applications.

As an example, the machine learning computing system 1830 can communicate with the computing system 1802 according to a client-server relationship. For example, the machine learning computing system 1830 can implement the machine-learned models 1840 to provide a web service to the computing system 1802. For example, the web service can provide an autonomous vehicle motion planning service.

Thus, machine-learned models 1810 can be located and used at the computing system 1802 or machine-learned models 1840 can be located and used at the machine learning computing system 1830.

In some implementations, the machine learning computing system 1830 or the computing system 1802 can train the machine-learned models 1810 or 1840 through use of a model trainer 1860. The model trainer 1860 can train the machine-learned models 1810 or 1840 using one or more training or learning algorithms. One example training technique is backwards propagation of errors. In some implementations, the model trainer 1860 can perform supervised training techniques using a set of labeled training data. In other implementations, the model trainer 1860 can perform unsupervised training techniques using a set of unlabeled training data. The model trainer 1860 can perform a number of generalization techniques to improve the generalization capability of the models being trained. Generalization techniques include weight decays, dropouts, or other techniques.

In particular, the model trainer 1860 can train a machine-learned model 1810 or 1840 based on a set of training data 1862. The training data 1862 can include, for example, a plurality of sets of ground truth data, each set of ground truth data including a first portion and a second portion. For example, the training data 1862 can include a large number of previously obtained multimodal content items, feature data extracted from the multimodal content items, prepared dishes, or recipes and ingredient lists associated with a multimodal content item.

In one implementation, the training data 1862 can include a first portion of data corresponding to instances of an order associated with a recommended prepared dish or list of ingredients being placed, an order associated with a recommended prepared dish or list of ingredients not being placed, or a user interacting with suggested merchants or items associated with the recommended prepared dish or list of ingredients. The data can be labeled indicating if an order was or was not placed or if the user interacted with one or more suggested items (and information about the interaction, e.g., length of viewing, data associated with the one or more items viewed). The labels included within the second portion of data within the training data 1862 can be manually annotated, automatically annotated, or annotated using a combination of automatic labeling and manual labeling.

In some implementations, to train the machine-learned model (e.g., machine-learned model(s) 1810 or 1840), model trainer 1860 can input a first portion of a set of ground-truth data (e.g., the first portion of the training data 1862 corresponding to the one or more representations of recommended item order conversions) into the models (e.g., machine-learned model(s) 1810 or 1840) to be trained. In response to receipt of such first portion, the machine-learned model outputs recommended prepared items or recipes and associated ingredient lists. In response to receipt of such first portion, the machine-learned model outputs a probability associated with a confidence score for the one or more recommended items. This output of the machine-learned models predicts the remainder of the set of ground-truth data (e.g., the second portion of the training dataset). After such prediction, the model trainer 1860 can apply or otherwise determine a loss function that compares the output data of the one or more machine-learned models (e.g., machine-learned models 1810 or 1840) to the remainder of the ground-truth data which the models attempted to predict. The model trainer 1860 then can backpropagate the loss function through the model(s) (e.g., machine-learned model(s) 1810 or 1840) to train the model(s) (e.g., by modifying one or more weights associated with the model(s)). This process of inputting ground-truth data, determining a loss function, and backpropagating the loss function through the model can be repeated numerous times as part of training the model. For example, the process can be repeated for each of numerous sets of ground-truth data provided within the training data 1862. The model trainer 1860 can be implemented in hardware, firmware, or software controlling one or more processors.

The computing system 1802 can also include a network interface 1824 used to communicate with one or more systems or devices, including systems or devices that are remotely located from the computing system 1802. The network interface 1824 can include any circuits, components, software, etc. for communicating with one or more networks (e.g., 1880). In some implementations, the network interface 1824 can include, for example, one or more of a communications controller, receiver, transceiver, transmitter, port, conductors, software, or hardware for communicating data. Similarly, the machine learning computing system 1830 can include a network interface 1864.

The network(s) 1880 can be any type of network or combination of networks that allows for communication between devices. In some embodiments, the network(s) can include one or more of a local area network, wide area network, the Internet, secure network, cellular network, mesh network, peer-to-peer communication link, or some combination thereof, and can include any number of wired or wireless links. Communication over the network(s) 1880 can be accomplished, for instance, via a network interface using any type of protocol, protection scheme, encoding, format, packaging, etc.

FIG. 18 illustrates one example computing system 1800 that can be used to implement the present disclosure. Other computing systems can be used as well. For example, in some implementations, the computing system 1802 can include the model trainer 1860 and the training dataset 1862. In such implementations, the machine-learned models 1810 can be both trained and used locally at the computing system 1802. As another example, in some implementations, the computing system 1802 is not connected to other computing systems.

In addition, components illustrated or discussed as being included in one of the computing systems 1802 or 1830 can instead be included in another of the computing systems 1802 or 1830. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. Also, terms such as “based on” should be understood as “based at least in part on”.

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and is not meant to be limiting.

What is claimed is:

1. A computer implemented method, including:
accessing multimodal content item data;
processing the multimodal content item data to generate a plurality of data objects comprising at least (i) one or more comestible items and (ii) context data;
processing the plurality of data objects to generate a predicted dish and dish data;
generating, based on the predicted dish and dish data, a list data structure comprising a plurality of ingredients and quantities of the respective ingredients;
processing the list data structure against a comestible item delivery service data structure to determine a deliverability status associated with the list data structure;
determining that the deliverability status for the list data structure indicates a deliverable status;
generating, automatically and responsive to determining that the deliverability status for the list data structure indicates the deliverable status, an action data structure, the action data structure comprising instructions, that are executable by one or more processors of a client device to cause initiation of a service request comprising one or more available items via an application programming interface associated with the comestible item delivery service; and
transmitting data comprising the multimodal content item and the action data structure to the client device.

2. The computer implemented method of claim 1, wherein processing the plurality of data objects to generate a predicted dish and recipe comprises:
generating an embedding vector for each respective data object of the plurality of data objects;
processing, by a machine-learned model, the embedding vectors; and
generating, by the machine-learned model, output comprising the predicted dish and dish data.

3. The computer implemented method of claim 1, wherein the dish data comprises a recipe for the predicted dish comprising one or more ingredient quantities and directions for preparing the predicted dish.

4. The computer implemented method of claim 1, wherein processing the list data structure against a comestible item delivery service data structure to determine a deliverability status associated with the list data structure comprises, for each respective merchant of a plurality of candidate merchants:
determining that the merchant is open and accepting orders;
accessing an inventory data structure associated with the merchant and determining that each item of the list data structure is found in the inventory data structure; and
generating the deliverable status for the merchant based on determining that the merchant is open, that the merchant is accepting orders, and that each item of the list data structure is found in the inventory data structure.

5. The computer implemented method of claim 1, wherein processing the list data structure against a comestible item delivery service data structure to determine a deliverability status associated with the list data structure comprises, for each respective merchant of a plurality of candidate merchants:
determining one or more merchants associated with the comestible item delivery service are at least one of: (i) closed or (ii) not accepting orders; and
generating, based on the merchant being at least one of (i) closed or (ii) not accepting orders, a deliverability status of the merchant as undeliverable.

6. The computer implemented method of claim 1, wherein processing the list data structure against a comestible item delivery service data structure to determine a deliverability status associated with the list data structure comprises, for each respective merchant of a plurality of candidate merchants:
accessing an inventory data structure associated with the one or more merchants and determining that one or more items of the list data structure are not present in the inventory data structure; and
generating, based on the one or more items of the list data structure not being present in the inventory data structure, a deliverability status of the merchant as undeliverable.

7. The computer implemented method of claim 1, comprising:
accessing interaction data indicative of user interaction with the multimodal content item;
generating, automatically and responsive to accessing the interaction data, a service request data structure;
processing, via the application programming interface, the action data structure to generate a service assignment;
transmitting data comprising the service assignment to a courier device;
monitoring progress of the courier device to perform the service assignment; and
automatically updating the user interface to provide updates associated with the progress of the service assignment.

8. The computer implemented method of claim 7, comprising:
determining that the service assignment has been completed; and
transmitting, based on determining that the service assignment has been completed, data comprising instructions that are executable by one or more processors of a client device to cause the client device to provide for display a notification comprising a request for uploading a new multimodal content item associated with the predicted dish.

9. The computer implemented method of claim 1, wherein the deliverable status is indicative of the items in the list data structure being available and deliverable.

10. The computer implemented method of claim 1, wherein the deliverability status comprises at least one of: (i) a value, (ii) a flag, or (ii) a signal.

11. The computer implemented method of claim 1, wherein the one or more available items comprise the one or more comestible items generated from processing the multimodal content item data.

12. A computing system comprising:
one or more processors;
one or more non-transitory computer readable media storing instructions that are executable by the one or more processors to perform operations, the operations comprising:
accessing multimodal content item data;
processing the multimodal content item data to generate a plurality of data objects comprising at least (i) one or more comestible items and (ii) context data;
processing the plurality of data objects to generate a predicted dish and dish data generating, based on the predicted dish and dish data, a list data structure comprising a plurality of ingredients and quantities of the respective ingredients;
processing the list data structure against a comestible item delivery service data structure to determine a deliverability status associated with the list data structure;
determining that the deliverability status for the list data structure indicates a deliverable status;
generating, automatically and responsive to determining that the deliverability status for the list data structure indicates the deliverable status, an action data structure, the action data structure comprising instructions, that are executable by one or more processors of a client device to cause initiation of a service request comprising one or more available items via an application programming interface associated with the comestible item delivery service; and
transmitting data comprising the multimodal content item and the action data structure to the client device.

13. The computing system of claim 12, wherein processing the plurality of data objects to generate a predicted dish and recipe comprises:
generating an embedding vector for each respective data object of the plurality of data objects;
processing, by a machine-learned model, the embedding vectors; and
generating, by the machine-learned model, output comprising the predicted dish and dish data.

14. The computing system of claim 12, wherein processing the list data structure against a comestible item delivery service data structure to determine a deliverability status associated with the list data structure comprises, for each respective merchant of a plurality of candidate merchants:
determining that the merchant is open and accepting orders;
accessing an inventory data structure associated with the merchant and determining that each item of the list data structure is found in the inventory data structure; and
generating the deliverable status for the merchant based on determining that the merchant is open, that the merchant is accepting orders, and that each item of the list data structure is found in the inventory data structure.

15. The computing system of claim 12, wherein processing the list data structure against a comestible item delivery service data structure to determine a deliverability status associated with the list data structure comprises, for each respective merchant of a plurality of candidate merchants:
determining one or more merchants associated with the comestible item delivery service are at least one of: (i) closed or (ii) not accepting orders; and
generating, based on the merchant being at least one of (i) closed or (ii) not accepting orders, a deliverability status of the merchant as undeliverable.

16. The computing system of claim 12, wherein processing the list data structure against a comestible item delivery service data structure to determine a deliverability status associated with the list data structure comprises, for each respective merchant of a plurality of candidate merchants:
accessing an inventory data structure associated with the one or more merchants and determining that one or more items of the list data structure are not present in the inventory data structure; and
generating, based on the one or more items of the list data structure not being present in the inventory data structure, a deliverability status of the merchant as undeliverable.

17. The computing system of claim 12, comprising:
accessing interaction data indicative of user interaction with the multimodal content item;
generating, automatically and responsive to accessing the interaction data, a service request data structure;
processing, via the application programming interface, the action data structure to generate a service assignment;
transmitting data comprising the service assignment to a courier device;
monitoring progress of the courier device to perform the service assignment; and
automatically updating the user interface to provide updates associated with the progress of the service assignment.

18. The computing system of claim 17, comprising:
determining that the service assignment has been completed;
transmitting, based on determining that the service assignment has been completed, data comprising instructions that are executable by one or more processors of a client device to cause the client device to provide for display a notification comprising a request for uploading a new multimodal content item associated with the predicted dish.

19. The computing system of claim 12, wherein the deliverable status is indicative of the items in the list data structure being available and deliverable.

20. One or more non-transitory computer readable media storing instructions that are executable by one or more processors to perform operations, the operations comprising:
accessing multimodal content item data;
processing the multimodal content item data to generate a plurality of data objects comprising at least (i) one or more comestible items and (ii) context data;
processing the plurality of data objects to generate a predicted dish and dish data generating, based on the predicted dish and dish data, a list data structure comprising a plurality of ingredients and quantities of the respective ingredients;
processing the list data structure against a comestible item delivery service data structure to determine a deliverability status associated with the list data structure;
determining that the deliverability status for the list data structure indicates a deliverable status;
generating, automatically and responsive to determining that the deliverability status for the list data structure indicates the deliverable status, an action data structure, the action data structure comprising instructions, that are executable by one or more processors of a client device to cause initiation of a service request comprising one or more available items via an application programming interface associated with the comestible item delivery service; and
transmitting data comprising the multimodal content item and the action data structure to the client device.
